(19) United States
(12) Patent Application Publication
(10) Pub. No.: US 2025/0273033 A1
(43) Pub. Date: Aug. 28, 2025

(54) SYSTEM, METHOD, AND APPARATUS FOR PROVIDING A LOCATION AND NUMBER OF ITEMS RETRIEVED SOLUTION FROM A USER-ACCESSIBLE STORED INVENTORY OF PLURAL ITEMS ON A ONE OR MORE SUPPORTING SURFACES

(71) Applicant: FAWN ENGINEERING CORPORATION, Clive, IA (US)

(72) Inventor: ANDRES MARTINEZ, Clive, IA (US)

(21) Appl. No.: 19/060,513

(22) Filed: Feb. 21, 2025

Related U.S. Application Data
(60) Provisional application No. 63/557,111, filed on Feb. 23, 2024.

(51) Int. Cl. G07F 9/02; G06F 3/042; G06Q 10/087; G06V 40/20; G07F 9/00

(52) U.S. Cl. CPC G07F 9/0235; G06F 3/0421; G06Q 10/087; G06V 40/28; G07F 9/006

(57) ABSTRACT

A system, method, and apparatus for generating an automatic detection solution of location and number of one or more user-selectable items retrieved by a user from at least one support (e.g., shelf or rack or drawer) in a interaction with an inventory of items. In one example, the interaction is a transaction from a micro market during a pre-determined user-interaction session. In some embodiments, at least one support is configured to store one or more user-selectable items along the front-to-back depth at each of a plurality of pre-determined solution detection areas along the side-to-side width of the shelf or rack. A weight sensor is installed at each support and configured to sense and report at least a weight of any user-selectable items on the support via a digital weight signal (and in some cases a total weight of the support and any items on the support). An item interaction detector is installed at or near the front plane of the one or more supports and is configured to sense and report user-interaction with any solution detection area of any support via a digital solution detection area signal. A programmable controller is configured to receive the digital solution detection area signal and any weight difference in comparing the digital weight signal before and after each user-interaction with a solution detection area, and automatically generate or store the automatic position solution of location and number of one or more user-selectable items retrieved from each solution detection area in the user-interaction by correlation of the solution detection area with digital weight signal before and after the user-interaction. The item interaction detector and weight sensor combination can be installed an operated in analogous manners in other contexts. A food pantry is one. A drawer is another.

### CROSS-REFERENCE TO RELATED APPLICATIONS

This application claims the benefit of Provisional Application U.S. Ser. No. 63/557,111 filed on Feb. 23, 2024, all of which is herein incorporated by reference in its entirety.

### 1 BACKGROUND OF THE INVENTION

### 1.1 Field of the Invention

The present invention relates to set-ups where one or more supporting surfaces (e.g., shelves, racks, drawers) support a predetermined inventory of items or products any of which are available for interaction, selection, and/or retrieval by a user (e.g., customer, worker, or person) and inventory monitoring. In particular, the present invention relates to a system, method, and apparatus for detecting and reporting both location of a product retrieved from the one or more supporting surfaces and, in some cases, how many items are retrieved from that location. In one aspect, the system tracks a hand relative to an XY plane correlated to the array of inventory items and, at any time, can resolve hand position relative that plane, and also tracks weight of the support and any items on the support to resolve if an item has been removed from a support by a decrease in weight correlated to an item. With those two indirect sensings, namely, hand tracking and weight tracking, inventories of items on one or more supports can be automatically monitored, and both an XY solution correlated to a specific item of inventory interacted with, as well as number of items removed from that XY interaction location can be resolved, whether one or more. The invention has applicability in a wide range of contexts. A few non-limiting examples are micro-markets, automated merchandising, and tracked inventories, whether in commercial, business, or home settings.

### 1.2 Related Art

A micro market is a self-checkout retail food or personal products establishment that replaces a bank of vending machines. In a micro market, a customer picks up a product from an open rack display or a reach-in non-refrigerated display case or refrigerated cooler or freezer, and then scans the UPC bar code or an RFID tag for each product at a payment kiosk. The customer pays with a single payment, e.g., cash, credit card or stored value card. Micro markets can be equipped with a 24 hours a day security system to monitor customers as they make selections and checkout.

Some micro markets are designed to be in closed locations, meaning a designated area in and at least moderately secured building or location. See NAMA Technical Bulletin Micro Markets 4-13 v.4.0 available online at http://www.vending.org/images/pdfs/micro-market/Tech_W7_bulletin_Micro_Market_v4.0.pdf. Certain state and federal government agencies have enacted laws or regulations about these types of micro markets. Other micro markets can serve employees inside a business location. Some micro markets can be in heavy public-traffic areas (e.g., pedestrian malls). See also National Automatic Merchandising Association (NAMA) at namanow.org/convenience-services/micro-markets/and the NAMA publication Mastering Micro markets (Digital Copy) available for a fee at imis.namanow.org/namaimis/Members/ItemDetail?iProductCode=MMM.

Another unique feature of a micro market is that it can operate without an employee present, just like vending machines. With reference to FIGS. 1A-B, top row, conventional vending machines 10 include an inventory of plural products or items 11 in a closed locked cabinet 12. A vending machine controller 13 can be preprogrammed to create an XY digital map (sometimes called a planogram or product map) of which product is or should be stored at which XY location in the cabinet (see planogram or product map 44 in diagrammatic example at FIG. 9C). Typically, a plurality of vertically spaced shelves 14 each support a plurality of horizontally spaced apart inventories of items. The XY locations 15 stored in the VMC 13 map allow a vending machine operator to track inventory by type of item, price of item, and other data, as well as inform the operator of when and how to restock according to the map. In typical vending machines, inventory items are stored in a lockable vending machine cabinet in plural side-by-side lanes of items (each lane holding at least one and many times plural items stocked front to back in the lane) across each of a plurality of vertically-spaced apart horizontal shelves or trays. A vertical plane in front of the trays essentially presents an array of XY positions relative to the fronts of the multiple trays; where for purposes herein, each tray represents a row of side-by-side lanes in the X direction of the plane. Each tray would be in a unique Y direction relative to the plane. As such, any inventory location in the machine can be references by the intersection of an X direction value (relative to some known origin) and a Y direction value (relative the same origin). The inventory items can, but do not necessarily have to be arranged in regular spacing from tray to tray. But for purposes of this disclosure, the array will sometimes be referred to as rows and columns relative an XY plane. But more precisely, each lane of each tray can be identified by its X and Y location relative such an XY plane. This allows a vending machine plan-o-gram to be essential a two-dimensional planar map of the planned inventory in the vending machine. For example, the bottom shelf or row could have a left-most lane denominated X₁ Y₁, a next lane to the right X₁Y₂ and so on to XᵢYₙ. The next higher, vertically-spaced shelf or row could have a left-most lane denominated X₂ Y₁, a next lane to the right X₂Y₂ and so on to X₂Yₙ. The top shelf or row could be Xₘ Y₁, a next row to the right XₘY₂ and so on to XₘYₙ. As such, the X direction value indicates the horizontal position on a tray which as is at a vertical position indicated by the Y direction value. The plan-o-gram can therefore use those location denominators to correlate actual physical location in the machine. Of course, other denominators can be used. But for purposes of this disclosure, the concept of an XY location refers to a naming system based on an XY plane. This is without regard to possible orientation of the XY plane, which could be vertical or substantially vertical, or horizontal or substantially horizontal; but possible at some oblique angle to either vertical or horizontal. Typically, such an XY denomination of inventory item locations for a given inventory space do not need or do not use any depth dimension or denomination because the items in any lane are typically the same item and do not have unique characteristics.

Some type of dispenser 16 for each XY location is automatically operated after user-selection from selection keypad 17 of a given item (and sometimes items) to, when operated, dispense a selected inventory item to a dispensing location (e.g., a delivery box 19). Indicia viewable by the customer at each XY location allows a customer to select from the keypad the XY location of the desired item. Sometimes there is a displayed map with identifying information, simulations, or images for customers to see what product is at each XY position.

A payment interface 18 built into the machine (or sometimes operable wirelessly such as from a smart phone) completes a purchase transaction, which automatically operates the appropriate dispenser to move the purchased item forward (or otherwise) to a user-accessible dispense location that is secure from access to any other items in the cabinet.

As is well known in the industry, the customer only visually (in the case of glass front machines), or sometimes with simulated images of or identifying information about products for each XY location, selects products. The customer is not able to physically handle items being considered for selection, easily read any notices such as nutritional content, or otherwise interact with the items. Also, the customer must rely on effective operation of the dispensers to dispense the correct selected product or products. As such, shown in FIGS. 1A-B top row, the conventional vending machine process includes (1) “key in order”, “pay”, and “grab”.

A relatively recent alternative to enclosed and locked vending machines is the micro market as shown at conventional micro market 20 in FIG. 1A, second row. An inventory of multiple products 21 can be stored in one or more cabinets 22 on one or more shelves 24. The cabinets can be open to customers or have doors that can either be unlocked or lockable. Like a conventional vending machine, some micro markets preprogram a controller by XY location 25 in each cabinet 22, data about each type of inventory 21. Other times there is not such pre-programming (e.g., if the system just relies on bar-code scanning of retrieved items by a customer). A payment interface 28 can include a barcode scanner 27 or other automated or semi-automatic subsystem that can read information from a user-retrieved product to identify it. That identification can include data about the product and price of the product preprogrammed into micro market controller 23.

In unlocked cabinets or exposed shelves or racks with inventory, the micro market 20 does allow a user to interact with any of the items, handle them, or read information from them, and the like. But it also relies on the honesty of the customer to scan any retrieved products and pay for them.

Some micro markets use lockable cabinets that have doors that can only be opened after a customer provides a pre-payment authorization such as via swiping a credit card. After a transaction with the customer, the system automatically relocks the door or doors. While this prevents removal of inventory items without a pre-authorization step (e.g. swiping a credit card so the system as at least pre-payment information before the door is unlocked), and this allows interaction with the products, it still must rely on the honesty of the customer as to how many products are retrieved and paid for.

Some micro markets attempt to deter intentional or unintentional removal of unpaid items. One example is use of cameras. For example, U.S. Pat. No. 11,526,843 to PepsiCo (incorporated by reference herein) uses both external and internal cameras. The external camera gets a record of a person interacting with the micro market. It can include image recognition techniques. An internal camera monitors removal of items. However, while the internal camera might create a record of how many items are removed, there is still risk of the customer intentionally or unintentionally removing more than items than end up being scanned and paid for. Also, if the camera view of an customer interaction at a product location is obscured or has poor resolution, it can be difficult to automatically evaluate, such as with machine vision, whether any product is removed, one product item is removed, or more than one, at least for purposes of charging the customer or recording inventory change. Such cameras require substantial effort to program for image recognition of each and every inventory item, and must be relied upon to correctly identify the inventory item.

Thus, the conventional micro market 20 differs from conventional vending machines 10. In one potential micro market sequence, a customer begins a session by providing some form of payment information to the payment interface 28. The system then allows physical interaction with products. A session ends by the customer retrieving one or more selected products, manually scanning the retrieved products, and checking out/paying based on what is scanned. As such, shown in FIG. 1A, second row, the conventional micro market process includes (1) “pay” (or at least validate a method of payment), (2) “grab”, (3) “scan”, and (4) “check out” (with finalized amount due).

As can be appreciated from the foregoing, there is room for improvement in this technical art. Some of those issues have been identified above. It has been recognized by the inventor that customers can benefit from being able to interact manually with potential products. This gives them more information for selection as to each individual customer's needs or desires. There are also benefits to allowing customers selection of a variety of different products, sometimes of the same type (e.g. different soft drinks in the same or different size containers; different snack options in the same or different containers, etc.) and allow, in one customer session, interaction with, selection of, and purchase of multiple items. There is room for improvement regarding automatically sensing both location of customer interactions in the inventory and number of items retrieved from each interacted location, in an effective, economical, practical, non-intrusive, and reliable manner. Some have attempted to track XY location and number of items removed with sensors at each XY position. This, of course, has cost and complexity implications. Some have attempted use of camera-vision to use image recognition as a way to determine the identity of a product removed, which has challenges regarding obtaining a clear field-of-view of all inventory items and cost and complexity of processing. Thus, as used herein unless otherwise indicated, the term XY position solution refers to the identification of position in two orthogonal directions of a plane (typically a facial plane over an of inventory items) of a 2D matrix or array of multiple inventory item supports as a way to uniquely identify where each inventory item should be stocked relative the plane. For example, in typical vending machines, two characters indicate an XY position solution to allow customers to punch in a desired item to be vended on a vending machine keyboard. One example could be a desired candy bar at the bottom tray, left-most lane which might be labelled X1Y1 in a denomination system of plural trays and plural lanes on each tray. Another example would be A1 in a denomination system of trays A-F (if six trays), and lanes 1-w on each tray, where w can be the same or different for each tray.

The inventor has also identified a need in the art to balance these competing interests of not only the customer, but also of the owner/operator of the micro market to both deter intentional or unintentional retrieval without payment but also to monitor inventory for purposes such as restocking, accounting purposes, and marketing purposes, to name a few. Also, there are some applications where there is a need to track theft rate. And there are applications where, for some users, it can provide automated inventory identification, tracking, and reporting for personal reasons.

The inventor also has identified a need for an effective and economical way to monitor customer interaction with inventory items, including number of items retrieved from any XY location without individual sensors at each XY location, which have inherent limitations and cost implications.

### 2 SUMMARY OF THE INVENTION

The technological solution according to one or more aspects of the invention is the subtle but effective combination of using two different automatic sensing techniques that each simultaneously monitor plural inventory locations, and use those separate but different sensing techniques to derive, on an item-location-by-item location basis, an inventory item location and removal solution without having costly individual sensors at each inventory item location. Combining the multi-item sensing techniques allows effective resolution to item by item locations as well as, if needed, number of items removed from a particular item location without even one item specific sensor at each item location. As such, the solution is cost-effective but also flexibly adapted to a wide range of end uses. For example, the solution can be applied to plural inventory item locations on a horizontal shelf, plural inventory item locations in a horizontal drawer; or both. It also can be applied to a set of multiple vertically-spaced micro market shelves, each with multiple inventory item product locations. It can be applied to multiple vertically-spaced home pantry shelves. It can be applied to drawers that horizontally support multiple inventory item locations, for example, expensive machine tool bits, different surgical instruments, or pharmaceuticals, to name just a few non-limiting examples.

In one aspect, the system tracks a hand relative to an XY plane correlated to the array of inventory items and, at any time, can resolve hand position relative that plane, and also tracks weight of the support and any items on the support to resolve if an item has been removed from a support by a decrease in weight correlated to an item. With those two indirect sensings, namely, hand tracking and weight tracking, inventories of items on one or more supports can be automatically monitored, and both an XY solution correlated to a specific item of inventory interacted with, as well as number of items removed from that XY interaction location can be resolved, whether one or more. In one non-limiting example, the XY hand tracking technique or subsystem is a curtain or field of sensing energy across the frontal or top plane of all the inventory items configured to resolve any hand penetration of the field to any XY inventory location by sensing disruption of the energy field at any averaged point in the XY plane. One non-limiting example of such a sensing field is a curtain of IR light that tracks and resolves XY position in the curtain by sensing disruption of the curtain continuously. Then, at any time, the weight tracking technique or subsystem can be referenced to deduce an indication of removal of one or more inventory items based on comparison of before and after weight measures relative the XY interaction. Another non-limiting example is use of digital camera(s) configured to image the XY inventory plane and recognize/sense an indication of a hand into that camera space, and configured to correlate sensed hand position in camera space with actual XY inventory plane position. The camera(s) can continuously track hand movement in the XY plane and, at any time, reference tracked weight to deduce if one or more inventory items are indicated to have been removed from the tracked hand XY position.

The first sensing technique is to generate a sensing field across a plane that covers the plural inventory locations, where the sensing field can effectively sense, track, and resolve a manual interaction with a specific inventory location down to the specific inventory item location.

The second sensing technique is to monitor weight of the support or supporting surface of plural inventory item locations, where the weight sensing can effectively sense and resolve down to the smallest inventory item if one or more inventory items have been removed based on comparing total weight of the support and inventory items prior to the sensed interaction versus after.

Thus, use of as few as two different sensors, each monitoring plural inventory item locations, can be used to resolve, on an inventory-item-location by inventory-item-location, any user interaction and removal instead of requiring at least one inventory item location sensing technique at each inventory item location. And as shown herein, the first sensing technique can use one sub-system to monitor for human interaction with any inventory item location on one or multiple inventory items supports, with each support having its own weight sensing technique, to allow the system to resolve an inventory item location and removal solution for each inventory item support. An example would be one system to monitor multiple, vertically-spaced apart horizontal inventory item supporting shelves in one micro-market cabinet. The cost and complexity of small digital scales or weight sensors, even if multiple ones are needed, is still quite economical, especially when a lesser number, and sometimes just one, of the first sensing technique is needed for the whole cabinet.

In one embodiment, the first sensing technique can by a curtain of light across the plane over all the inventory item locations with light detectors that can sense a perturbation, disruption, or blockage of light in at least two directions relative the curtain to effectively resolve the sensed perturbation, disruption, or blockage at least to any of the multiple inventory locations. One example is complimentary linear arrays of IR light emitter/detector pairs along one direction to resolve disruption of one or more beams in that direction (e.g., an X direction), and a second pair of emitter/detector arrays along a perpendicular direction (e.g., a Y direction) to the first pair to resolve disruption in that perpendicular direction. Each pair of detectors can resolve the disruption in the plane of the light curtain down to a specific inventory item location. In another non-limiting example of digital camera(s) or imager(s) for the XY position resolver, camera space identification of a hand and tracking of its movement in camera space can be correlated to actual hand position relative to the actual inventory of items, and allow combination with the weight tracking to complete the total solution of XY interaction location and number of items removed.

One example of a second sensing technique can be a single digital scale, weight sensor, load sensor, or other sub-system that senses a weight indicative of the total number of inventory items on an inventory support and has a sensitivity to resolve a change of weight at least as small as the weight of the lightest inventory item intended for that inventory support. Automatic comparison of total weight before versus after a sensed interaction allows the system to monitor for a condition indicative of removal of one or more inventory items from that inventory support. If so, the system knows both inventory item location on the support and the number of inventory items removed from that location.

Thus, the system provides an inventory item location and number solution that can be used beneficially. For example, it can be used to calculate amount owed for the removed items in a micro market setting. It can be used to track which and how many machine tool bits have been checked out by a worker. It can be used to track which and how many food pantry items have been interacted with and removed by a home owner to help them know when to replenish any pantry items.

In the case of an IR frame that creates a curtain of IR energy in a plane for hand tracking, the amount of energy used for IR light curtains and digital scales of this scope is relatively minimal. The size and cost of IR light curtains and digital scales is relatively small, which allows non-disruptive integration into a variety of set-ups, either as original equipment or retro-fitted. And the capital cost, installation cost, and maintenance costs of such sensing techniques are also relatively small, at least as compared to visible light illumination, heating or cooling sub-systems, and the like. As will be appreciated by those skilled in the art, for those systems that use one IR light curtain emitter/detector combination for multiple vertically-spaced shelves, and one weight sensor per shelf, the system knows which of weight sensor data to use by its user interaction position solution with the IR light curtain. In other words, the light curtain informs the system which before and after shelf weight should be evaluated for indication of removal of one or more inventory items. In the case of digital cameras for hand tracking, the cost of such camera or imagers is relatively low, particularly when just one or two cameras can monitor an array of plural inventory items.

Some embodiments include a priori set up or configuration. For example, some systems can be pre-programmed with a plan-o-gram, product map, or other database that assigns a particular inventory item for each inventory item location. Thus, a sensed user interaction by the first sensing technique will automatically correlate the sensed location with a particular inventory item. Thus, if the second sensing technique indicates a removal of one or more items from that location, the system knows not only how many are removed but specific details of the type of item. Some embodiments can include adding the average weight of each inventory item to that a priori knowledge. This can help in the accuracy and precision of whether or not to indicate an item removal and, if so, accuracy and precision of whether one, two, three, etc. are indicated to have been removed. Those skilled in the art appreciate that such pre-programming of plan-o-grams, product maps, and the like, including a variety of information about individual items, is well-developed. This includes the ability to modify the plan-o-gram or the like at any time via re-programming with conventional computer-based tools. The use of microprocessors and well-developed operating systems provides these features. But a subtlety of the disclosed system is how both an inventory item location and indication of removal can both be automatically sensed without at least one individual sensor at each inventory item location. Even with a priori programming of what inventory items should be at each physical inventory item location, the ability to automatically detect a user interaction at any inventory item location without location-by-location individual sensors is a challenge, as is automatically detecting whether one or more items has been removed from that location.

Other aspects of embodiments of the invention include the ability to apply the system in a variety of end uses and applications in a straightforward manner. As mentioned, it can be applied to inventory item supports that are a single horizontal shelf or horizontal drawer, but also to plural vertically-spaced horizontal shelves. And, of course, a system can be applied to any number of shelves, sets of shelves, drawers, or sets of drawers.

Another aspect of embodiments of the invention includes the ability to operably communicate the first and second sensing subsystems for any given shelf, set of shelves, or drawer with some type of intelligent digital controller. As mentioned, digital signal processors, micro-processors, micro-controllers, are just a few examples. And any of those can, in turn, communicate with other intelligent controllers or devices, either directly or through hard wiring including both local area networks (LANs) or wide area networks (WANs); but also, wirelessly through wireless LANs or WANs; but also any combination of wired and wireless. This allows communication with any of a variety of local or remote computers, databases, or smart devices. Those skilled in this technical field understand that such is a well-developed area and that there are both proprietary and commercially available systems and platforms that could be used for the same. One example would be to tie together a plurality of systems according to this disclosure for one site (e.g., one micro-market location with multiple inventory item supports). Another example would be to tie together plural systems at various different sites (e.g., a number of micro-markets owned or operated by one entity). Another example is to at least allow communicate between single or multiple systems according to this disclosure of one owner/operator and a remote computer or server and database(s) to allow owners/operators to both collect and store data from one or more such systems for purposes of tracking, inventory, maintenance, etc., but also allow remote programming or reprogramming from a central location. And, still further, another example is communication of one or more such systems of a variety of unrelated owners/operators to a central remote computer(s)/database(s) that could allow aggregation of data from such disparate sources for any of inventory management, machine-learning or artificial intelligence training sets and training, maintenance, or more meta-data purposes.

### 3 BRIEF DESCRIPTION OF THE DRAWINGS

FIGS. 1A and B are a diagrammatic illustration of a comparison of aspects of the present invention (lower row) relative to examples of prior art set ups (top and middle rows).

FIG. 2A is a diagrammatic illustration of a generalized embodiment of a system that uses hand tracking and weight tracking of an array of inventory items to resolve XY interaction and removal of one or more inventory items from an XY location according to one or more aspects of the disclosure.

FIG. 2B is a diagrammatic illustration of a generalized method of a system that uses hand tracking and weight tracking of an array of inventory items to resolve XY interaction and removal of one or more inventory items from an XY location according to one or more aspects of the disclosure.

FIG. 3A is a diagrammatical view of one example of aspects of the present invention applied to a micro market.

FIG. 3B is a block diagram of components of an embodiment according to one or more aspects of the present invention and its connection to a micro market payment subsystem.

FIG. 4A is a flowchart of one exemplary embodiment of a method according to one or more aspects of the invention which monitors and correlates detected user interactions with items on a shelf or rack that have been pre-correlated to data about each item at each location with shelf weight monitoring by load cells.

FIGS. 4B-E are diagrammatic illustrations of aspects of embodiments according to the invention, including at FIG. 4B an exploded view of an IR frame with light energy curtain across its framed space that can be mounted in front of or over aa inventory item support having a scale to monitor change in weight, and a preprogrammed plan-o-gram that is stored with an XY position and item(s) removed solution circuit or controller which is essentially an inventory map that correlates XY item position with the particular item and its average weight for each XY support position, and then at FIGS. 4C-E, how the combination is configured to detect a user interaction with a supported inventory item by correlation of the user's fingers or hand relative the position of disruption of the light curtain (which is pre-correlated with the actual XY positions on the support), and monitors for change of weight indicative of removal of an inventory item from the support.

FIGS. 5A-B are diagrammatic illustrations illustrating the combination of the position solution by XY interaction detection combined with shelf weight information, where a single item from a single shelf is interacted with and retrieved.

FIGS. 6A-B are similar to FIGS. 5A-B but show interaction and retrieval of multiple items from a single interaction XY location.

FIGS. 7A-C are similar to FIGS. 5A-B and FIGS. 6A-B but show interaction and removal of an item from an XY location and automatic operation of a dispenser to move a succeeding stored product at that location forward to frontmost position for a next customer session.

FIGS. 8A-B are isolated illustrations of one example of a photoelectric XY location detection subsystem according to one aspect of the invention, using IR emitter and detector sets to form an IR curtain across a space.

FIGS. 8C-D are diagrammatic illustrations indicating how the IR frame of FIGS. 8A-B can operate to give XY position.

FIG. 8E is an example of a circuit to produce an XY location solution based on the IR frame of FIGS. 8A-B.

FIG. 9A is a perspective view of a set of vertically spaced shelves each supported by load cells to monitor weight of each shelf and any items on each shelf in an open shelf or rack display or cabinet that may or may not have a door which is lockable or not.

FIGS. 9B-C diagrammatically illustrate how each shelf of FIG. 9A could have a preprogrammed set of laterally spaced X positions or product lanes (sometimes called columns), each lane with one or more items or products to be interacted with and/or retrieved, and how a shelf (in one of multiple Y positions for plural shelves) in FIG. 9A can be supported by two load cells to monitor and derive weight of shelf and any items on the shelf. FIG. 9C is one example digital map or database that is preprogrammed to correlate each XY position for one or plural shelves and data about each item in each lane at each exposition of each XY position shelf, including weight of the item at each position.

FIG. 9D is a diagrammatic electrical connection diagram of how weight measures are derived from the load cells of FIG. 9B and communicated to a computer for correlation to detected XY interaction of the IR frame of FIGS. 8A-E to arrive at a location solution that includes not only XY position of interaction, but number of items retrieved from that XY interaction.

FIG. 9E is a diagrammatic view of plural shelves or racks with items stored in laterally spaced positions whether individual items per lane or multiple items per lane including vertically stacked as opposed to front to rear rows of items.

FIG. 10 is a diagrammatic view of examples of the product solution according to FIG. 2 applied to any of a plurality of shelves or racks in different locations whether in the same physical or geographic location or widely dispersed with digital communication wired or wireless with both digital devices used by customers or remote computers.

FIG. 11 is a highly diagrammatical view of an optional feature according to the present invention which adds a digital display at the shelf or shelves/racks using the position solution according to the present invention to give immediate visual feedback to consumers regarding products interacted with and retrieved and/or a speaker to audibly provide the same or similar information (such as by text to speech conversion).

FIG. 12 includes additional optional arrangements of interconnection of embodiments of the invention with external devices; and other types of payment, inventory control and marketing data collection that could be usable with embodiments of the present invention.

FIGS. 13A-C are illustrations of an example of a light curtain frame that can resolve XY position inside its frame perimeter based on a human finger(s) or hand breaking a plane of light beams.

FIG. 14 are illustrations of another example of a light curtain frame that can resolve XY position of a finger(s)/hand breaking a light curtain.

FIG. 15 is an illustration of use of one or more aspects of the invention with respect to a household inventory of pantry items, and where the XY plane is vertical and the inventory item supports are vertically-spaced pantry shelves.

FIG. 16 is an illustration of use of one or more aspects of the invention with respect to inventory items in a drawer, where the XY plane is horizontal and the inventory item support is a drawer floor or the whole drawer, with non-regular XY areas (here optionally delineated by bins for each inventory item or items.

FIGS. 17A and B are diagrammatic illustrations of using a combination of hand tracking and weight tracking to resolve XY position and number of items removed from an inventory of items on plural shelves, each shelf with plural lateral lanes. FIG. 17A shows a first state where a user hand interaction with one inventory item is sensed and tracked as to XY position. FIG. 17B shows removal of one item from that XY position and how weight tracking can allow derivation of how many items from that XY location are removed.

FIG. 18 is a diagrammatical illustration of one non-limiting alternative embodiment of hand tracking that can be used with one or more aspects of the present disclosure, here one (or more) digital cameras that can be configured to recognize and track a hand relative to the XY frontal plane in front of an array of inventory items and resolve XY position to any inventory item to then use with weight tracking to provide an XY position and number of items removed solution for the hand interaction XY location.

### 4 DETAILED DESCRIPTION OF EXEMPLARY EMBODIMENTS OF THE INVENTION

### 4.1 Overview

It will be appreciated that the present invention can take many forms and embodiments, variations obvious to those skilled in the art will be included within the invention, which is not limited to the embodiments presented herein. For example, in one form, a single support can support the mass of laterally spaced-apart lanes of inventory items and utilize an XY position solution sensor effective in resolution to derive a human finger/hand interaction with one of those lanes, plus a weight sensor subsystem that monitors weight of the support and any inventory items on the support. A combination of XY position solution of a human interaction with change in weight of the support allows estimation of not only what inventory item was interacted with, but whether or not it was removed; and how many are indicated to have been removed.

For example, in one non-limiting form, a single support can support the mass of laterally spaced-apart lanes of inventory items and utilize a photoelectric detection subsystem effective in resolution to derive customer interaction with one of those lanes, plus a weight detection subsystem that monitors weight of the single support and any inventory items on the support prior and after human interaction. In essence, this combines a hand tracking sensor subsystem to resolve XY interaction position with the inventory and a weight tracking subsystem to resolve whether, and how many, inventory items are removed from the XY interaction location to, thus, provide an overall solution of XY position and number of items removed.

In one example, in one non-limiting form, plural supports can each support the mass of laterally spaced-apart lanes of inventory items and utilize a photoelectric detection subsystem effective in resolution to derive customer interaction with one of those lanes on any of the supports, plus a weight detection subsystem for each support that monitors weight of that support and any inventory items on that support. Thus, a single photoelectric system for all supports and individual weight sensor. In other embodiments, that combination can be utilized for a plurality of vertically spaced apart shelves, each with a plurality of lanes, with either a single photoelectric item interaction detection subsystem or one for each shelf along with a weight sensor for each shelf. Furthermore, plural of the position solution subsystems according to embodiments of the invention can be used, each with one or more inventory item supports and each of the one or more inventory item supports being freestanding and user accessible or supported in a cabinet or drawer that is freely user accessible, or supported in a cabinet or drawer that has an unlocked front door or cover or lockable front door or cover. Still further embodiments of the invention can be applied to a variety of different types of micro market set ups including plurality of different cabinets of an abutment in a closely spaced arrangement, multiple shelves or racks distributed throughout a space even if not in abutment, or even multiple shelves or racks in different rooms. Embodiments of the invention can be applied in analogous ways to other vertically spaced inventory item supports, including in home pantries, and in analogous ways to other horizontal inventory item supports, such as drawers.

It is to be understood that alternative embodiments can use different hand tracking sensing subsystems. One non-limiting example is a camera (or plural cameras) that are configured to have a field of view of the entire array of inventory items being monitored, sense a hand interaction into that field of view, track hand movement, and resolve any indication of inventory item interaction to an XY location. That XY interaction solution can be combined with weight tracking to achieve a full solution of XY interaction and number of items removed.

Furthermore, the invention can be applied to a variety of different types of items or products. One example is food and beverage whether refrigerated or unrefrigerated, or even warmed. But another is non-food or beverage products, such as are well known in the art. Other examples in the automated merchandising industry also apply. Non-limiting examples are personal care products, phone and gift cards, machine tools and bits, surgical tools and medical supplies, pharmaceuticals, and other inventory control dispensers or setups. Other end uses are, of course, possible. A few non-limiting examples include a home food pantry to keep track of inventory, tracking number and type of towels or linens removed from a shelved inventory of the same, and so on. Additionally, aspects of the disclosure can be applied in to a variety of arrays of inventory. For example, not only shelved inventory on one or more shelves having a frontal vertical XY plane, but also inventory in drawers having a frontal or top horizontal plane.

Still further, it will be appreciated the invention can be added retroactively into existing shelves/racks, cabinets, drawers, shelves, etc., or incorporated as original equipment.

Still further, as is within the skill of those skilled in the art, the detection outputs of the components of the position solution subsystem according to the invention can be effectively communicated to and interpreted by existing automated checkout systems of at least similar types to micro markets, as well as to other systems depending on need or desire. For example, detection outputs of first and second sensing subsystems can be converted to digital formats that can be effectively interpreted and used by conventional micro market check out and payment processing components. Such detection outputs can be used in beneficial ways in other end uses of the system disclosed herein or one or more of its aspects.

It is to be appreciated that the embodiments below are by example only and not by way of limitation.

### 4.2 Generalized Embodiment

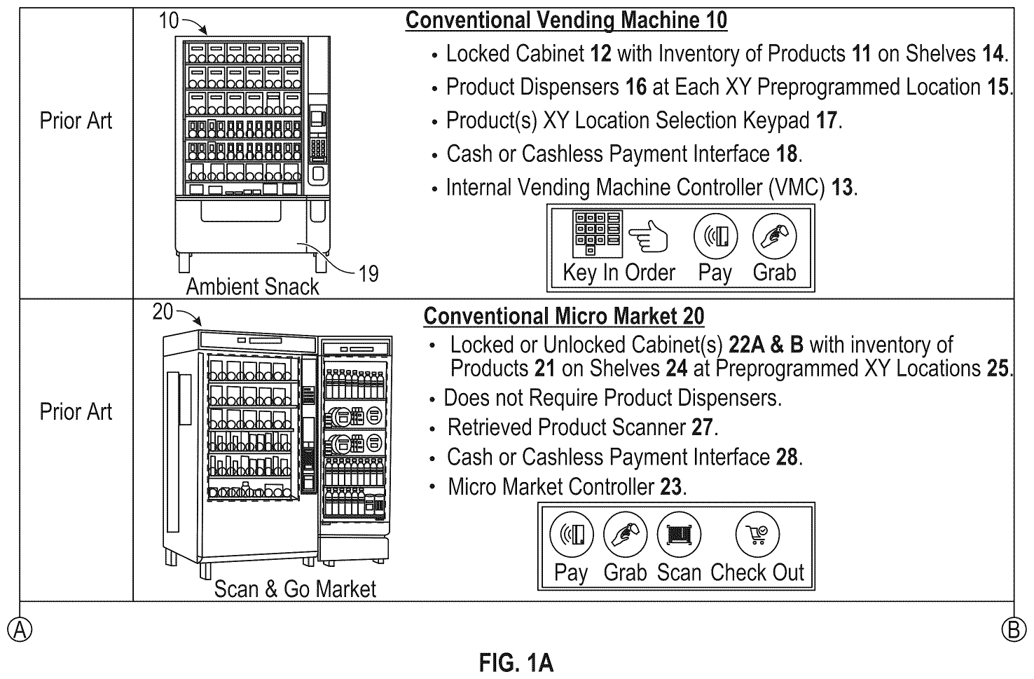

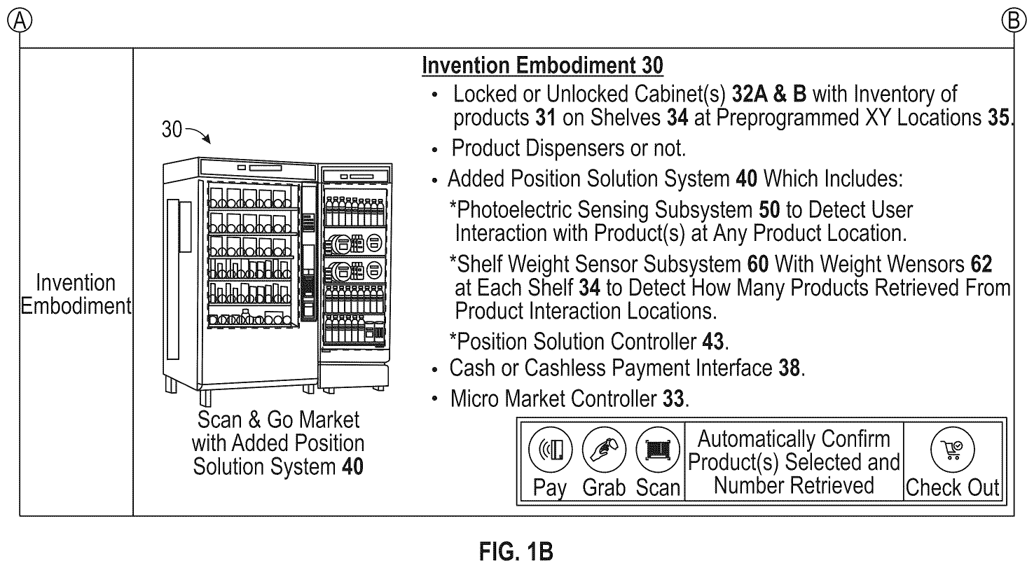

The third row of FIGS. 1A-B illustrates a general embodiment according to the present invention. Its general differences to the prior art paradigms of conventional vending machines (top row) and conventional micro markets (middle row) can be seen.

The generalized embodiment of the present invention is in the context of one or more supports supporting one or more inventory items for interaction and retrieval with a user, an XY position solution subsystem can be used to detect user interaction with a resolution to any of those XY positions along each support, and a weight sensor subsystem for each support that can monitor for any change of total weight of the support and its contents and correlate it to a detected interaction. The XY position resolution is essentially by tracking indications of a human hand relative to a frontal XY plane over an array of inventory items on one or more supports, with the ability to track and resolve XY position correlated to any actual inventory XY position at any time. A weight tracking sensor subsystem can monitor total weight of any support assigned to inventory and, at an appropriate time or indication of a human interaction with an inventory item, resolve number of items removed from that XY inventory location by comparing tracked weight prior and after the interaction. The change in weight can be correlated to a priori stored average weight values for each of the inventory items. The combination can give higher confidence of not only what inventory item was removed, but how many interactions occurred and/or how many inventory items are indicated to have been removed from the interaction location. This can beneficially include, prior to the interaction, a computer or controller preprogrammed with specific inventory item data, including weight, for the inventory items at each XY support location, which can assume all products in the lane of that XY location are the same inventory item. Thus, the addition of the position solution sub-system for XY position of inventory item interaction and the weight sensing subsystem for change in weight, can provide information regarding what inventory item location was involved with an inventory item retrieval and how many inventory items from that location are indicated to have been retrieved (as in removed from that support).

Therefore, the resolution of the position solution subsystem is configured to be effective for resolution of the smallest item for each XY position for each support. There can be same or similar sized items across all the supports or a variety of different sized inventory items at different XY positions on the supports. The resolution of change of weight of the overall support and any items on the support can be many times sufficient to distinguish removal of the lowest weight single item.

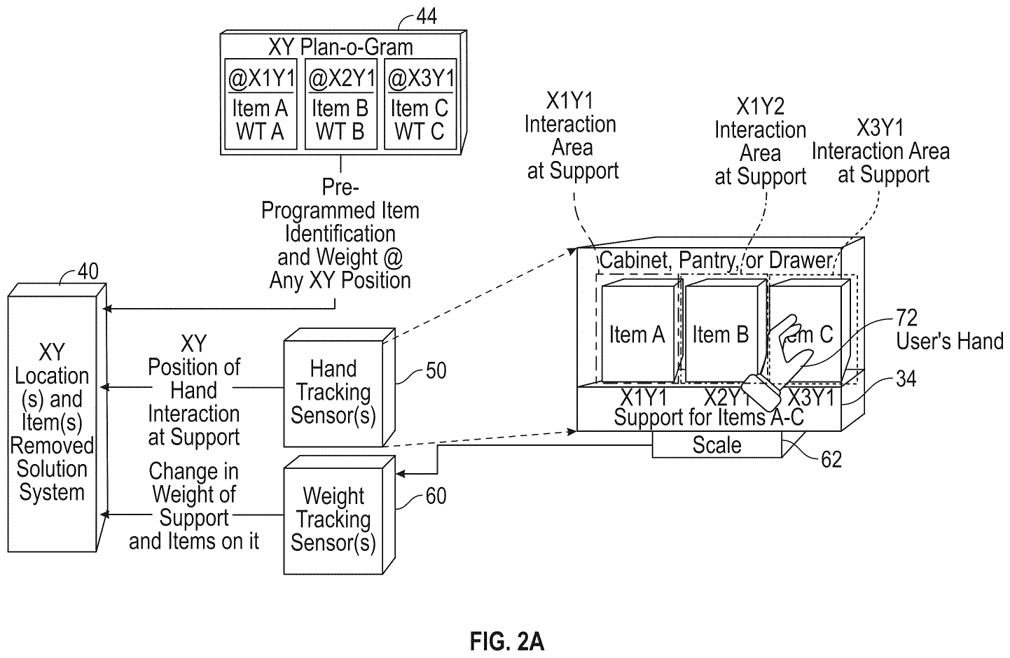

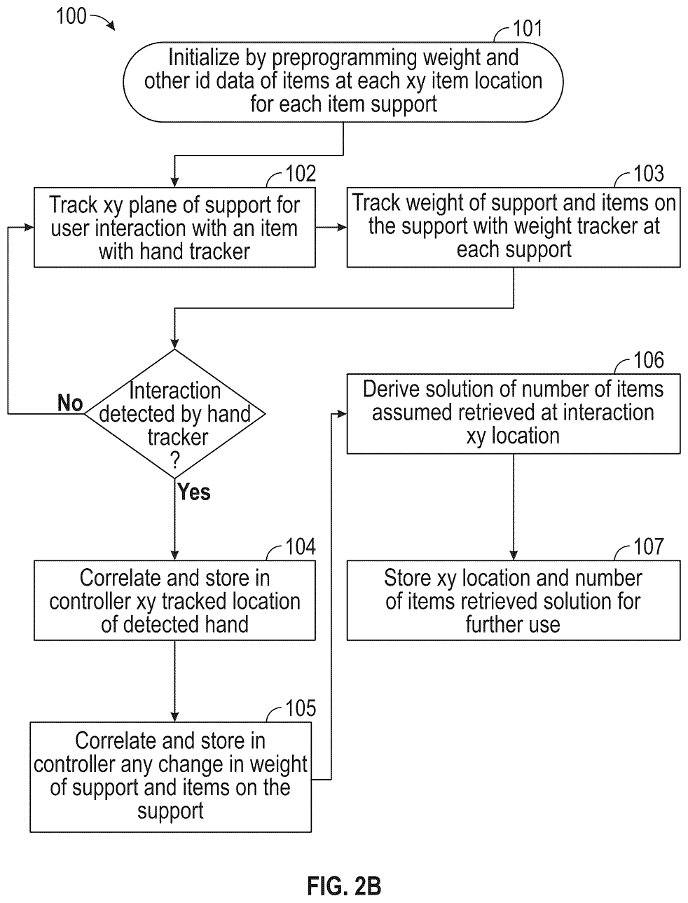

With reference to FIGS. 2A-B, a generalized embodiment according to one or more aspects of the disclosure is illustrated. A system according to this embodiment 30 can be used to simultaneously monitor for human interaction with any inventory item on support 34 (here the example is one support of three inventory items A, B, C, but it could be one item or more items and/or one or more items on more supports that can be concurrently monitored). A hand tracking sensor or sensor(s) and system 50 does the concurrent monitoring. Any hand entry sensed by 50 can also track movement of a hand. This would be similar to how a computer mouse works. Sensor 50 senses and recognizes a customer hand 72 and it is correlated with an XY plane that is, in turn, correlated with the actual XY plane in front of the inventory. Thus, as the hand moves relative the sensing technique, sensor 50 tracks XY position and change of position if the hand moves, like a computer would track physical user movement of a computer mouse by then reporting XY position as a digital value that can be used by a processor. In some embodiments, a planogram 44 is, a priori, programmed with the desired XY locations of each inventory item and can include average weight of each. Weight tracking sensor(s) subsystem 60 at each support (here only one) thus track any change of weight of support 34 and any inventory items on it. Thus, at any desired or programmed time, an indication of hand proximity at an inventory item by hand tracker 50 can then refer to tracked weight from weight tracker 60 at some time before a tracked XY hand position and then at some time after, compare them, and if there is a change of weight that correlates to the a priori weight of the interacted with identified inventory item, system 40 can generate a solution of both what inventory item was interacted with by XY position (and reference to the a priori planogram 44) as well as how many items are indicated to have been removed. As will be appreciated by those skilled in the art, the correlation of XY space of hand tracker 50 with actual physical XY space at the inventory can be through calibration or other techniques for each configuration of inventory and support or supports. And the correlation of weight of support and items supported on it can likewise. The final solution by 40 is derived from the digital values of tracked XY hand position from 50 and change of weight from 60. Thus, these two indirect techniques can be combined to provide that solution by hand tracking and weight tracking of more than individual inventory items.

The generalized method 100 of FIG. 2B follows that same paradigm. Initialization with a priori information (step 101) is followed by simultaneous XY hand tracking (step 102) and weight tracking (step 103) as discussed above. At a selected or appropriate time or condition, XY hand position (step 104) and any change of weight (step 105) are compiled and stored. They are then used to generate a solution of XY interaction position and number of inventory items removed from that position (step 106). The solution can then be available for further use (step 107). One non-limiting example is number of items to charge a customer. Method 100 provides not only what inventory item type was removed, but resolves if one or more were removed. Another non-limiting example is number of items removed for purposes of tracking inventory. Again, hand tracking of a number of inventory items simultaneously, and weight tracking of a number of inventory items simultaneously, is leveraged into tracking both with just two indirect sensing techniques that allow a solution of both inventory item interaction resolved to any inventory item, and number of inventory items removed from any interaction location. This can be for one inventory item or plural inventory items. The hand tracking and weight sensing, when correlated, allow resolution of a solution for each and every of as many inventory items are in inventory and as many as are interacted with.

In the specific context of a micro market as one non-limiting example of an end use, the overall micro market system senses information right at each XY location with resolution to inform a checkout system of what the product is that was actually retrieved and also how many were retrieved. This is in contrast to the vending machine of first row of FIG. 1A, which relies solely on keyed-in X and Y position from a keypad by a user. It also differs from a micro market such as the second row of FIG. 1A that relies totally on the honesty of the customer regarding which products retrieved are actually scanned and paid for.

One or more aspects of the present invention can, therefore, provide the benefits of micro market customer interaction with items in inventory but track both product type/price and number of products indicated removed during a customer session from one or more XY locations in each cabinet. This can inform the checkout/payment system of the correct payment needed from the customer.

As will be appreciated, there could still be bad faith customers that retrieve but do not pay for the indicated retrieved items from a session. Typically, the system will have at least some customer payment method information. But even if the bad faith customer avoids payment, the system of the invention can record any error or offset from what its position solution system indicates are the total number of products and type of products retrieved in a customer session and allow an owner/operator to monitor and account for any intentional or unintentional removals that are unpaid. It also allows, at the point-of-sale checkout interface, at least the ability to notify the customer there may be an offset between indicated products and number retrieved versus those scanned for payment, and try to compel a resolution by the good faith of the customer. In some micro market situations, there may be an employee that monitors the micro market and can try to resolve any indicated discrepancy with the customer.

And, additionally, other end uses of one or more aspects of the present invention can benefit in similar or analogous ways to the micro market context. For controlled inventory end uses, one or more aspects of the invention allow both identification of type of inventory item being interacted with by a human, plus an indication of if and how many inventory items are removed from that location. Using well-known existing user-identification and validation technology, the system can include techniques to know specifically what human is interacting with the inventory items, what qualifications or permissions that human has relative to any and all such items, and records and stores that human identifying information and validations for any further use or review. The technology of the disclosure, in one or more aspects, can be applied to non-controlled inventory end uses. One example is home pantries. One non-limiting example is to assist a blind person in identifying what pantry inventory item he/she is interacting with, and then whether or not it is removed for use. This can include whether it comes back into place in inventory. As such, the person can also be informed if an inventory item has not been placed back (via some type of audible alarm), or if the inventory item needs replacing/replenishment. And other end uses can include a variety of form factors for the support(s) of the inventory items. One non-limiting example is in a drawer, which can use the XY position solution sub-system (the XY plane is horizontal as opposed to vertical with a shelf or set of shelves).

Thus, one technical solution according to one or more aspects of the invention is illustrated in FIG. 1B third row. For better understanding, a generalized method according to one or more aspects of the invention is illustrated there in the context of a micro-market end use. As discussed elsewhere, one or more aspects of this generalized method can be applied in analogous ways to other end uses. Non-limiting examples are vending machines, automated merchandizing machines, controlled inventory cabinets, lockers, or drawers, and home uses including but not limited to home pantries. In this non-limiting example, the technique or subsystem to resolve XY position is an IR frame generating a curtain of IR light across the frontal plane of the inventory array in the micro-market cabinet to simultaneously monitor for and track a hand that reaches to an of the inventory. It can report an XY interaction position at any time to a XY and item removed solution controller. As mentioned, other XY hand tracking techniques are possible.

Applicable at least to micro markets with locked or lockable cabinets, micro market 30, according to one or more aspects of the invention, can also be used with or without dispenser mechanisms.

An XY position and number retrieved solution system 40 is added to each cabinet 32. System 40 includes two sub-systems 50 and 60, namely a photoelectric XY position detector subsystem 50 added to each cabinet 32 and a shelf weight sensor 62 added to each shelf or inventory support of each cabinet 32. A micro market checkout payment subsystem 23/27/28, like a vending machine, is preprogrammed to store a map of XY position in the cabinet of each item correlated or matched to product information about each product at that location. That data includes not only identification of the product including price, but also weight of individual products.

The photoelectric sensing subsystem 50 can detect and store each consumer interaction with a product correlated to time. The weight monitoring subsystem 60 can monitor combined weight of each shelf and any inventory on it in a continuous manner and store those weights (at least for a given time period, for example, the length of a customer session) correlated to time. Thus, system 40 can extract from stored data for the time of any detected interaction by subsystem 50 the weight before and after the interaction. This combination of data allows the position solution of what product location was interacted with (by correlating preprogrammed information about what product is at that XY location) and is there an indication at least one product at that location has been removed (by dividing a before versus after weight drop by the preprogrammed weight of a single product at that XY location).

As such, shown in FIG. 1B, the micro market process according to an embodiment of the invention includes (1) “pay”, (2) “grab”, (3) scan”, (4) “automatically confirm type and number of each product grabbed” by the product solution subsystem 40, and (5) “check out” based on the product solutions.

For each detected product interaction with subsystem 50 (triggered by detection of a user's hand relative to the XY plane in front of the items in a cabinet 32), a shelf weight measurement from a shelf weight sensor 62 for that shelf (as one of a set of weight sensors 62 of the weight monitoring sub-system 60) and what that shelf supports at the time of measurement can be compared to weight of shelf and contents on it just prior to and just after a detected XY interaction. According to a predetermined algorithm, if a change in shelf weight signal is correlated to an item interaction, a position solution controller 43, monitoring the photoelectric subsystem 50 and shelf weight monitoring subsystem 60, can collect and store a record that is indicative of not only what product was retrieved but total number of products retrieved from that XY position retrieved, because of the preprogrammed XY map and weight of products for that cabinet. Then, this information can be used by the micro market checkout subsystem to essentially load into the customer's virtual shopping cart data indicating an intent to purchase the number of that product.

By straightforward calculation, if the difference in weight prior to interaction to after interaction matches the weight of a single item for that XY position, the position solution controller 43 can assume that one product from that XY location has been removed/retrieved and can send on to the micro market checkout system that one item from that position needs to be paid for. If the difference in weight prior and after interaction at the detected XY location is within a predetermined range indicative of two items, two items can be charged to the customer or put in the virtual shopping cart, and so on. There are some circumstances where a customer wants two or more identical items in a single session.

Moreover, in a single customer session, the same detection correlation, called a position solution, can be detected using the photoelectric subsystem 50 and shelf weight subsystem 60 for multiple different XY positions in a single cabinet. In a single session, system 40 could detect a product interaction at a first XY position in a cabinet 32 while monitoring for any weight change on its shelf, and detect a product interaction at a second XY position in that cabinet while monitoring for any weight change on it shelf (the same shelf or a different shelf). Thus, system 40 could report out data to inform the checkout/payment solution shopping cart of product retrievals from plural XY positions and the number of retrievals from each XY position.

Still further, a similar combination 40 of photoelectric sensor 50 and shelf weight sensors 60 for each of a plurality of cabinets 32 can feed position solutions (number of items indicated retrieved from any XY position in any of the plural cabinets 32) either to individual position solution controllers 43 at each cabinet 32 or a single such controller 43 operatively connected to each system 40, to store and make available for the checkout system not only identification of XY locations in multiple cabinets of product interactions but how many products have been retrieved from each interacted XY position. The customer thus can pick as many of the same location products or diverse location types of products as desired for a given session to then checkout such as by scanning them. The checkout system thus has a way to double check whether what is scanned for checkout correlates to what the product solution system 40 indicates have been retrieved. If there is any offset, some sort of intervention can automatically be displayed to the customer.

As will be appreciated, the position solution(s) for each cabinet can be accomplished effectively and economically. In one embodiment the photoelectric system 50 is an off-the-shelf IR light curtain planar position resolver frame 54 that can be installed at or near the plane in front of the shelves of inventory in each cabinet 32 and around, “framing”, the inventory items on the plural shelves. Penetration of a user's hand through its IR curtain in that plane allows derivation of an XY position relative any of the shelves in the cabinet. A weight sensor subsystem 60 can effectively and economically be installed that includes a weight sensor for each shelf. One example is inexpensive load sensors 62 between each shelf and its supporting structure in each cabinet such that they would continuously report overall weight of the shelf and items of the shelf. Thus, when a customer interaction is detected, the system 40 can compare overall weight before and after the interaction. If the weight after is lower than before, and the difference is indicative of removal of one or more items from the shelf, the interaction XY location (form which the product identification, including weight and price, can be derived from the preprogrammed XY inventory map) and the number of such products removed (by dividing the difference in before and after weight by the individual product weight preprogrammed into the XY inventory map for that product location) allows the controller 43 to compute the product and number of that product to charge the customer.

As will be appreciated by those skilled in the art, such IR curtain subsystems 50 are capable of detection resolution effective to discrimination between typical micro market product shelf locations for a wide variety of sizes and weights of products. For example, resolution down to under one inch (or even smaller) is possible.

As will be appreciated by those skilled in the art, such load cells for weight detection subsystem 60 are capable of detection resolution within a margin of error sufficient to distinguish between even quite small and light products. For example, a small bag of potato chips has a weight of a few ounces or less. Such load cells can effectively distinguish removal of just one from an entire shelf that might include plural much heavier items such as soda cans. As such, if it can distinguish removal down to a resolved light object like that (an ounce and less). As such, it can likewise detect removal of two or more of the same.

It will also be appreciated that the present invention can be applied in a variety of contexts. For example, it could be applied to any shelf or rack supporting one or more objects for interaction and retrieval. It is not necessarily limited to a vending or automated merchandising or micro market context. One example might be for healthcare supplies such as sets of medical gloves. Another might be machine tools in a manufacturing setting (such as drill bits). The application would include preprogramming for each XY position on each shelf or rack of data identifying the product and its weight.

It will be further appreciated that one or more aspects of the invention can be utilized with other subsystems. One example, as given above, would be addition to or integrated with original equipment for a micro market cabinet or cabinets. The position solution controller(s) 43 can be operatively communicated to the checkout system for the given application to provide position solutions for products detected as being both interacted with and retrieved, including calculation of whether one or more than one has been retrieved from each interaction XY location.

And, of course, one or more aspects of the invention can be installed and used with operative connection to a local or wide area network that communicates with a variety of cabinets, whether or not at the same general physical location or widely dispersed locations. Thus, one owner/operator of multiple such combinations can continuously monitor retrieved inventory by consumers for, inter alia, notifications for need for restocking, alarms or alerts regarding potential attempts (intentional or unintentional) to underpay for items indicated retrieved during the session, but also for accounting records for a whole set of micro market or selling locations. This includes gathering data allowing the owner/operator specifics about overall purchases versus retrievals for a given time period (hour/day, week, etc.), but also such information that can be data-mined to evaluate customer purchase patterns for each cabinet or location which can be used not only for planning for inventory replenishment but also for marketing purposes, such as is known by those skilled in the art.

### 4.3 Specific Embodiment 1

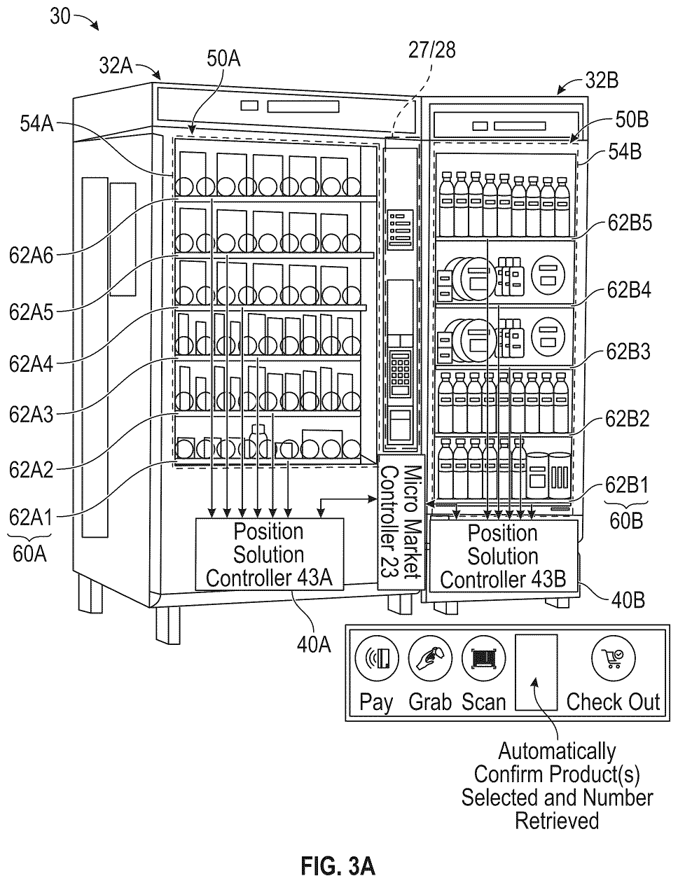

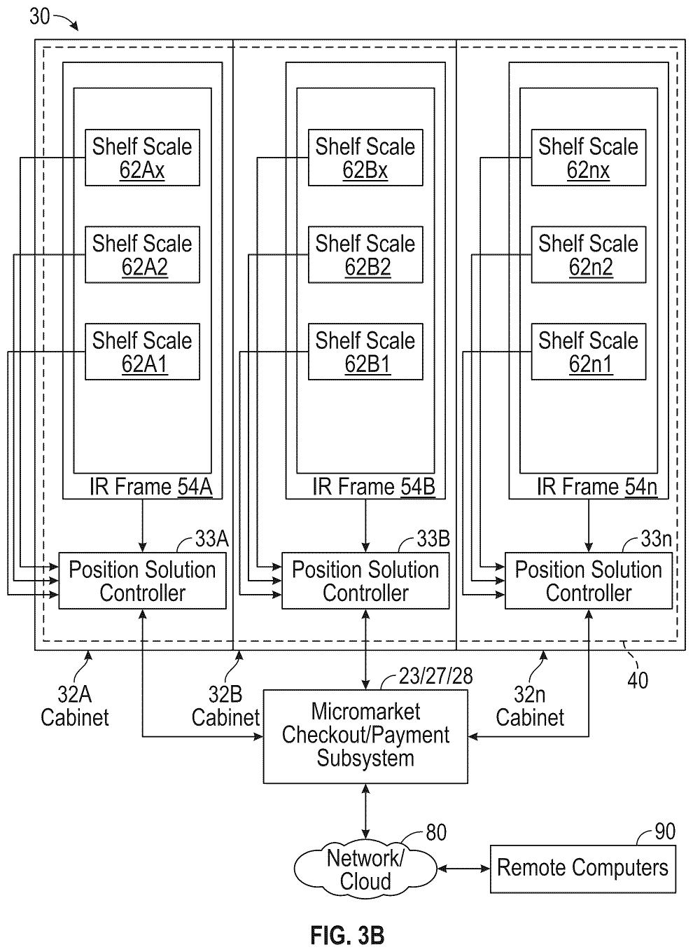

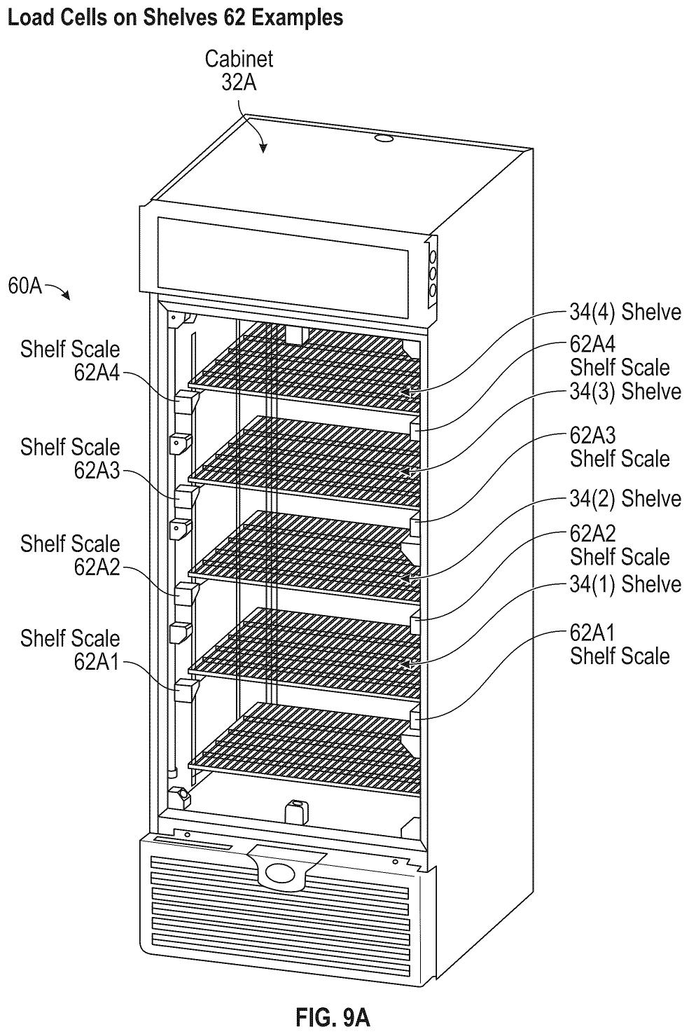

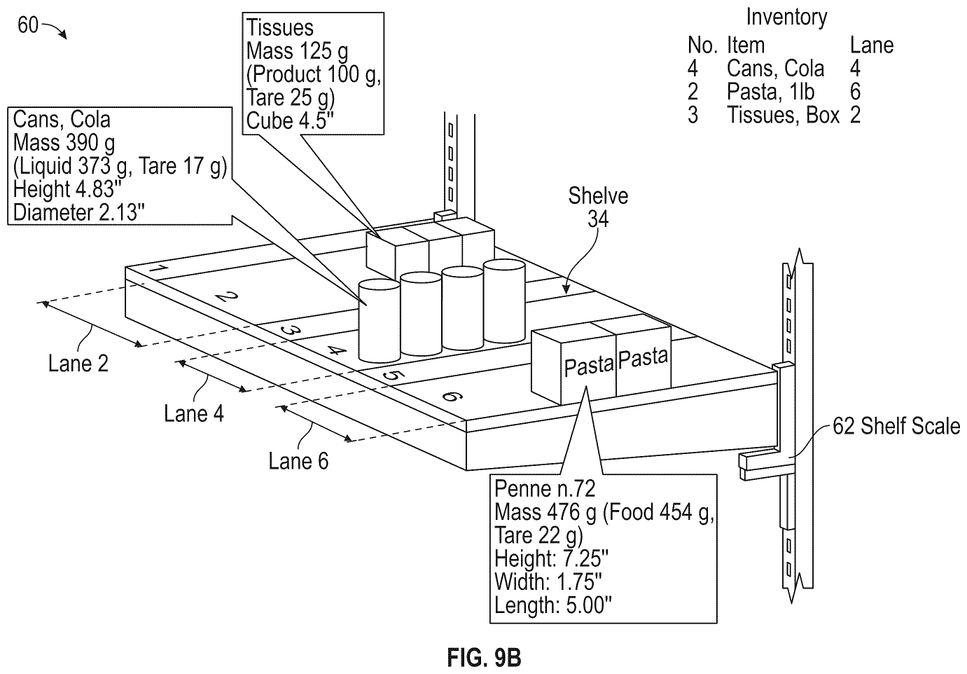

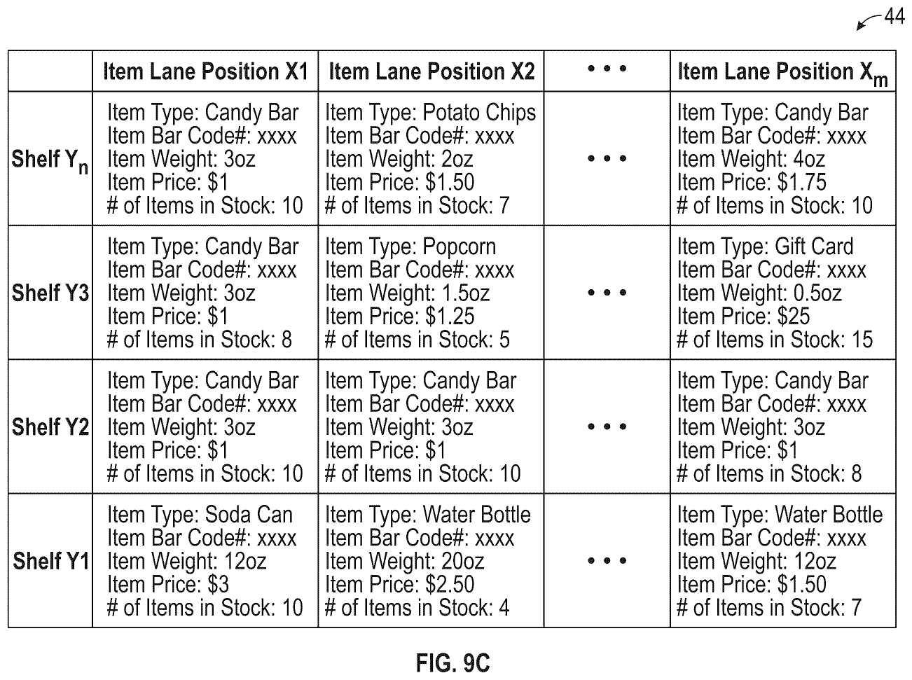

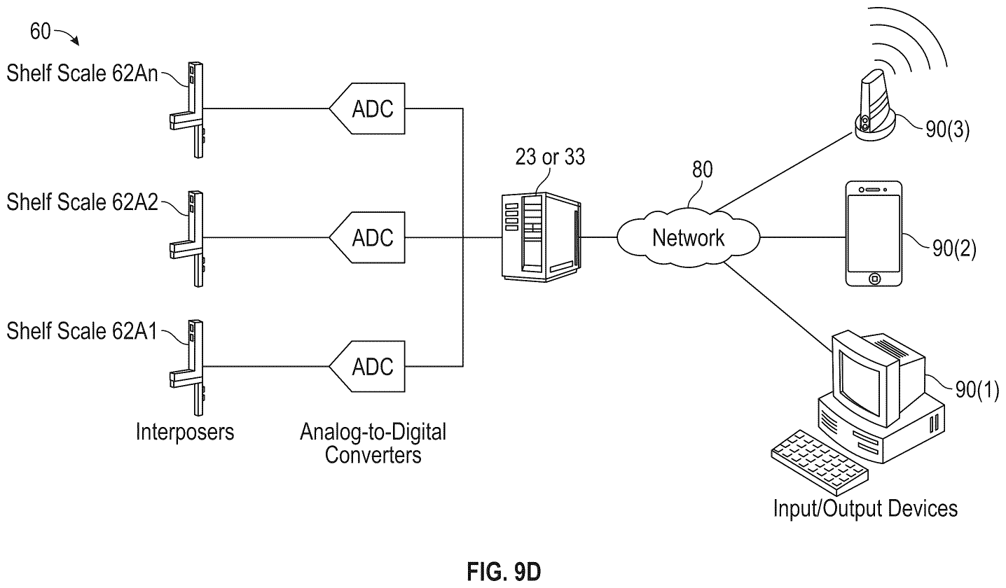

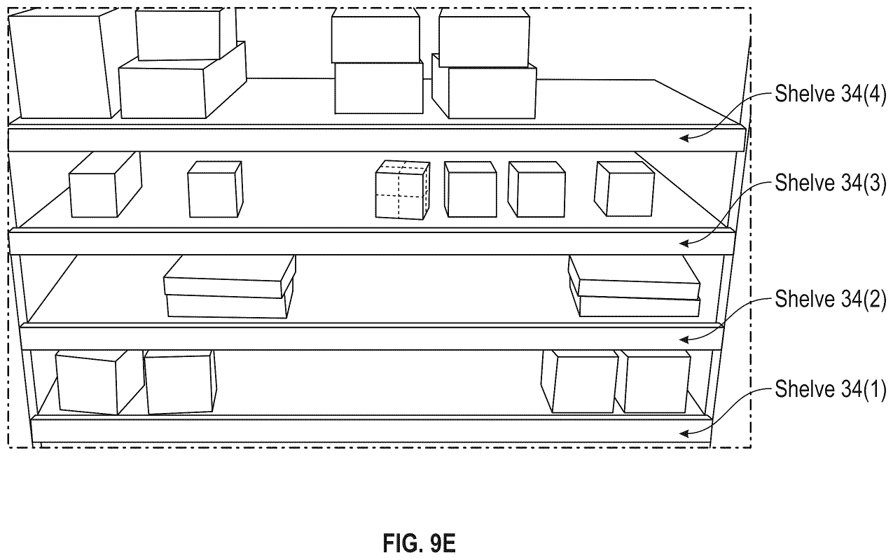

With reference to FIGS. 3A-B to 7A-C, the position solution described above according to aspects of the invention is shown in more detail relative to a micro market set up such as shown in FIG. 3A. The micro market set up 30 according to this embodiment includes two cabinets 32A and B, each having a varied inventory of snack and beverage items 31 on a plurality of vertically spaced shelves 34. A checkout/payment module (scanner 27, payment solution 28) can be communicate with a micro market controller 23 preprogrammed upon stocking of inventory 31 to correlate each X position on each shelf 34 (the preprogramming knows Y position from shelf position in the XY plane) relative to data about identity of the product and also weight of each product. One example can be seen at FIG. 9C, which is essentially a conventional digital map similar to those set up in vending machines that matches product data with XY location. In particular, the product data includes weight of individual products for that location.

This can be accomplished, such as known by those skilled in the art, by a computer or controller or microcontroller that is either specially set up for system 30 or a part of a micro market set up (e.g., controller 43). The XY locations 35 linked to product identity and weight data of the digital map of the XY layout, can be associated with automated dispensers (helical rotated coils or other) like in vending machines or simply inventory reported on the surface of a shelf or rack.

Consistent with many existing micro markets, system 30 includes a checkout payment module 23, 27, 28 that would include a built-in barcode scanner for users to scan the barcode of retrieved products for a given product picking session as well as a payment solution (cash, credit card, mobile phone wallet, etc.).

As illustrated diagrammatically in FIG. 3A, system 30 includes the following added subsystems.

First, a photoelectric XY position solution system 40 is installed in a manner that it discerns with an optical sensing subsystem 50 a finger or hand of a user penetrating a vertical plane in front of the inventory 31 and resolves it sufficiently to one X location on one shelf at height Y. As such, it can resolve XY position of the interaction.

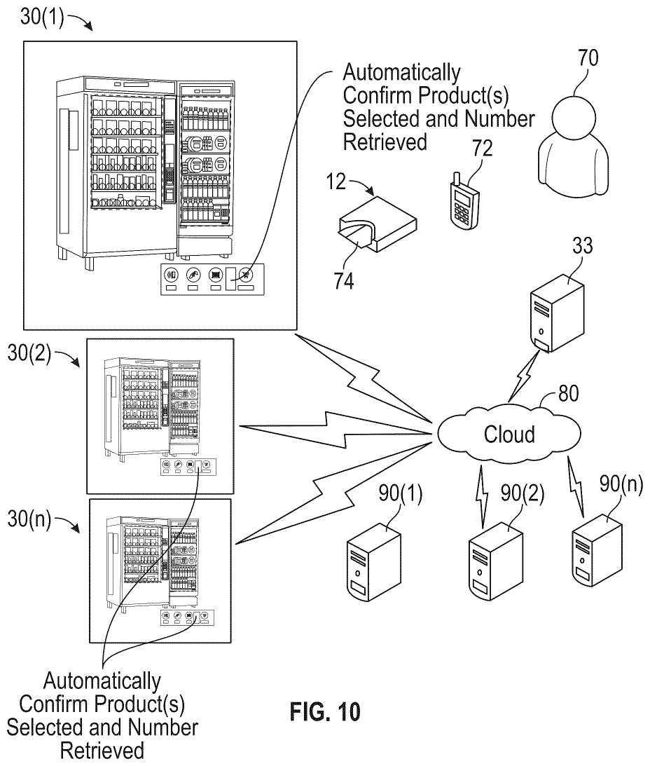

As will be appreciated, this detection will occur through penetration of a finger or hand through a photoelectric curtain. The disturbance of that photoelectric field can be resolved in both X and Y directions sufficiently for needed resolution. In one example, the photoelectric subsystem 50 is an IR frame 54 (e.g., FIGS. 10A-E) that utilizes serial arrays of IR emitter sets 52 and matched detector sets 53 across X and Y dimensions of an open area framing the inventory 31.

Secondly, a shelf weight sensing subsystem 60 is operatively configured for each shelf or rack 34 to monitor the combined weight of each shelf or rack 34 (which will remain constant over time) and any inventory 31 on the shelf or rack (which will change based on any addition or removal of one or more products from the shelf or rack). In one example, the shelf weight sensor(s) for each shelf or rack of the weight monitoring subsystem 60 are one or more load cells 62 with sufficient resolution relative to each shelf or rack to detect and report a change of weight at least indicative of removal of just one of the lightest items of inventory from the shelf or rack. As is well known in the art, load cells that are positioned between a shelf or rack and all points of its support can be calibrated for quite small detectable weight changes that would cover most if not all currently types of vendable or micro market type items.

As shown in FIG. 3A, the outputs of the XY photoelectric subsystem 50 (which produces an indication of XY interaction with a product) and shelf weight subsystem 60 (which produces a signal indicative of current combined way of shelf/rack and any items on shelf/rack), can be fed to a position solution controller 43 that is programmed to correlate an XY interaction with any change of weight.

That controller 43 can be a separate, relatively inexpensive programmable controller that communicates with subsystems 50 and 60 for each cabinet, and then produces a position solution that includes not only an indication of XY position of any product retrieval but also number of products retrieved from that XY position.

That information can then be passed on to an extant micro market checkout subsystem 27, 28, which can include a controller or computer 23 that is programmed to operate a check out for each customer session. Alternatively, controllers 43 can be integrated into micro market system 23, 27, 28. Thus, the addition of a relatively inexpensive and unobtrusive photoelectric subsystem 50 and shelf weight subsystem 60 for each shelf can provide this valuable, correlated information for further use. In the example of FIG. 3A, for example, one photoelectric system 50 for each cabinet can be installed framing the area in front of all of the inventory in that cabinet 32. Small, economical weight sensors (e.g., load cells 62) can be installed between load points of each shelf or rack 34 and any support on or to which they are suspended. Wires from each can go to controller 43 to communicate the respective measurements of subsystems 50 and 60.

As indicated in FIG. 3B, one example of a photoelectric subsystem 50 is an IR frame 54 that has complementary sets of IR emitters/receivers for X and Y axes. Such frames 54 can be an inch or less in width and depth and thus be installed unobtrusively. Thus, they can be installed at or near the plane of the fronts of the product supports (shelves). This allows an indirect correlation between sensed XY interaction in the plane of photoelectric subsystem 50 and the actual inventory item positions on their respective supports shelves. The XY solution of subsystem 50 is an indirect correlation of XY position in the plane of frame 54 and the actual forwardmost inventory item positions in the cabinet. Thus, the ability to mount frame 54 not only around multiple inventory item positions but also near or even at the plane of the forwardmost points of those inventory items promotes effective accuracy and precision in estimating where any XY human penetration of the plane of frame 54 correlates to actual XY position of inventory items. Again, as discussed elsewhere, a subtle but important aspect of this embodiment of the invention is the ability to monitor for human interaction with a plurality of inventory items instead of with individual sensors or monitors at each inventory item location.

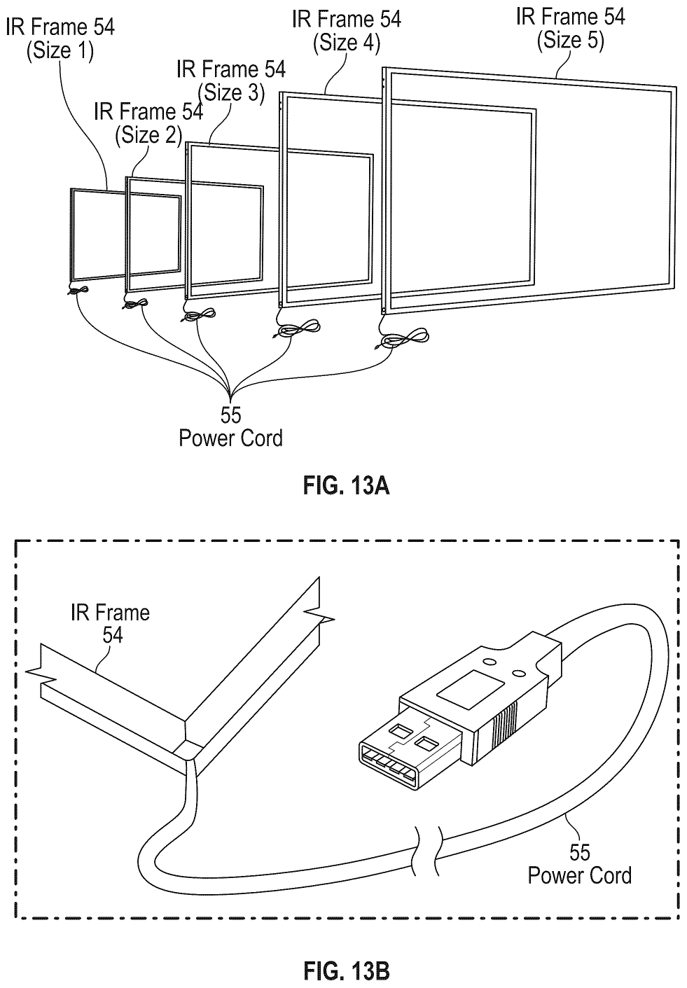

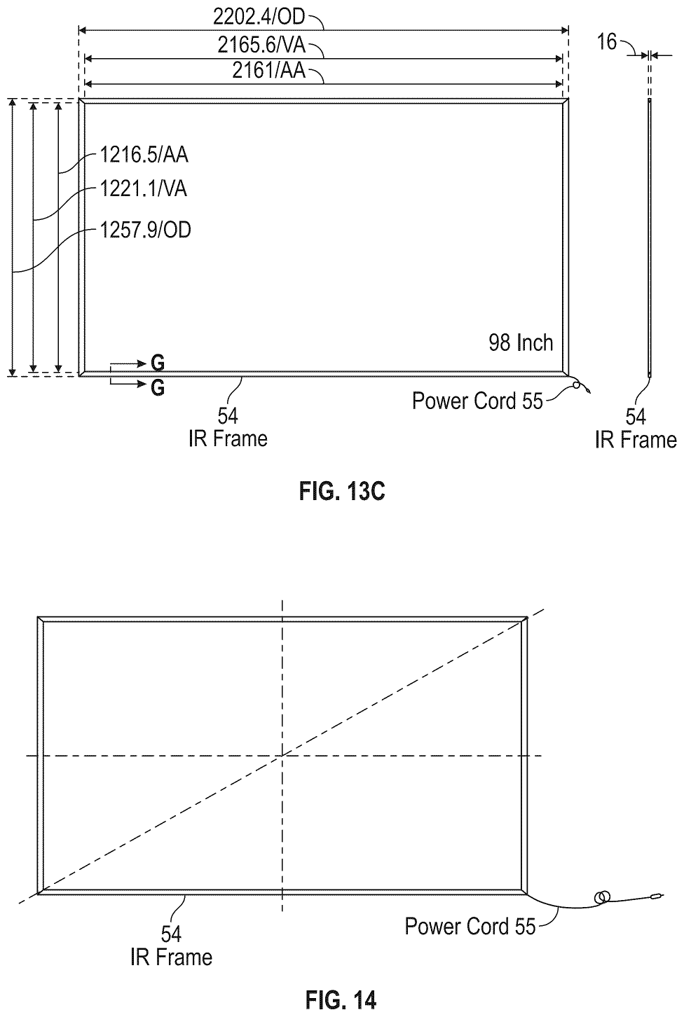

It one example of this Specific Embodiment 1, IR frame 54 has a complete open area internally for reaching through of users to any shelf. The IR emitter sets 52 and detector sets 53 are relatively low power consumption. Details about how such complementary sets of pairs of IR emitters/detectors, aimed appropriately across the interior plane of frame 54, essentially create a curtain of light across that plane, can be seen in U.S. Pat. No. 9,013,450 B1, incorporated by reference herein. The individual beams of one set of emitters covers an “X” direction across frame 54 (e.g., left to right); whereas the other set of emitters covers a “Y” direction (e.g., top to bottom). As discussed in U.S. Pat. No. 9,013,450 B1, by appropriate selection of the IR emitters (e.g., power, beam width, frequency, spacing, etc.) and complementary placement of IR detectors, one per emitter beam, after calibration relative to free space between each pair (no physical blockage), a baseline operating intensity indicating no human interaction can be set for the emitter/detector pairs. And, by typical calibration, a threshold diminution of intensity consistent with blockage by a human finger, fingers, or hand can be set. Subsystem 50 can then report any perturbation or diminution indicative of a human finger(s)/hand to a resolution in the “X” direction of one or a few emitter beam widths that correspond to sufficient differentiation between side-by-side inventory items, plus a similar resolution in the “Y” direction. As such, the combined resolutions effectively provide an XY position solution for any of the inventory items to a resolution that is unique to each of them. This is without individual sensors at each inventory item location. Some commercially-available IR frames, and details about their operation, can be seen at FIG. 13 and FIG. 14, as further discussed infra.

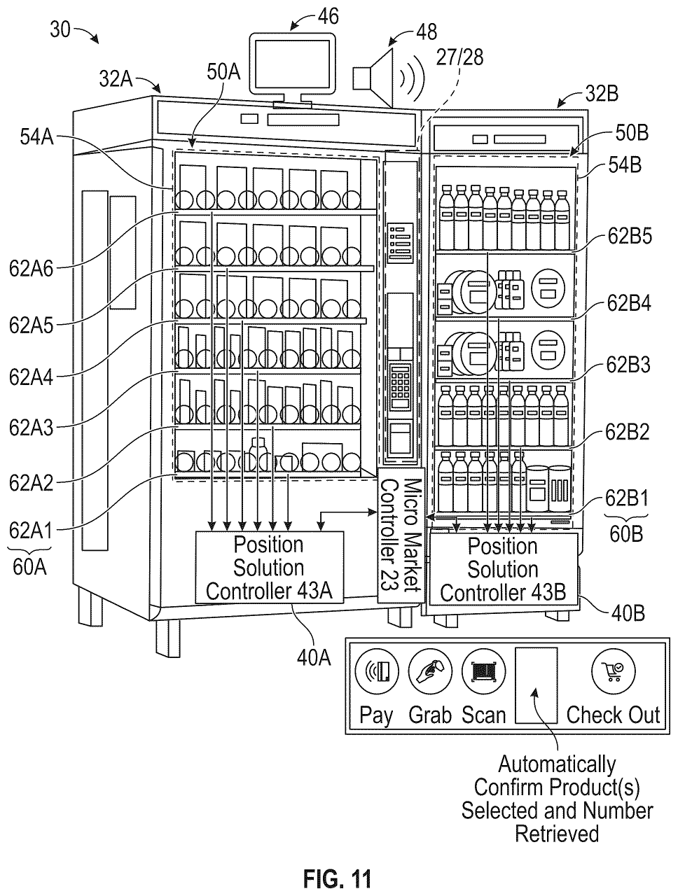

Similarly, weight sensing subsystem 60, for example, load cells 62, are relatively inexpensive and can be small in form factor (see e.g., FIGS. 11A-B). Installed at each shelf or rack 34, wires can be routed to a position solution controller 43. Again, detecting disruption of an IR curtain with sufficient resolution to derive XY position in the plane in front of all the shelves provides information resolved down to each XY lane based on the user moving a hand to grab a forward most item for possible selection. This is information of physical interaction right at each XY position 35. And the weight sensing is a physical measurement at each shelf 34. Thus, unlike cameras, which must rely on image or shape recognition with a field-of-view of the entire interior, or rely simply on the good faith of customers to check out a retrieved item, the present invention provides enhanced automated position and number of products retrieved from the position for the customer session. As can be further appreciated, the set-up of FIG. 3B can operate continuously as long as the micro market is open for business. And the power usage is relatively small, the additions are easy to retrofit or build into each set of shelves or racks and/or cabinets, and the two pieces of information detected and collected and stored can be used effectively. Examples of shelf weight or load sensing set-ups and operation can be seen at, U.S. Pat. No. 10,614,415 B1 and U.S. Pat. No. 10,466,095 both incorporated by reference herein.

As further diagrammatically illustrated in FIG. 3B, the position solution including number and identity of product retrieved, can be used by the checkout subsystem of the micro market to inform the checkout system of what product or products were retrieved and how many of them for charging the customer appropriately. And, similar to what is presently available in the art, the checkout system could in turn be operatively connected to some network or the cloud 80 and utilized by remote computers 90(i)-(n) for any number of purposes. See, e.g., FIG. 10. Examples are inventory monitoring, inventory management, marketing data, and other.

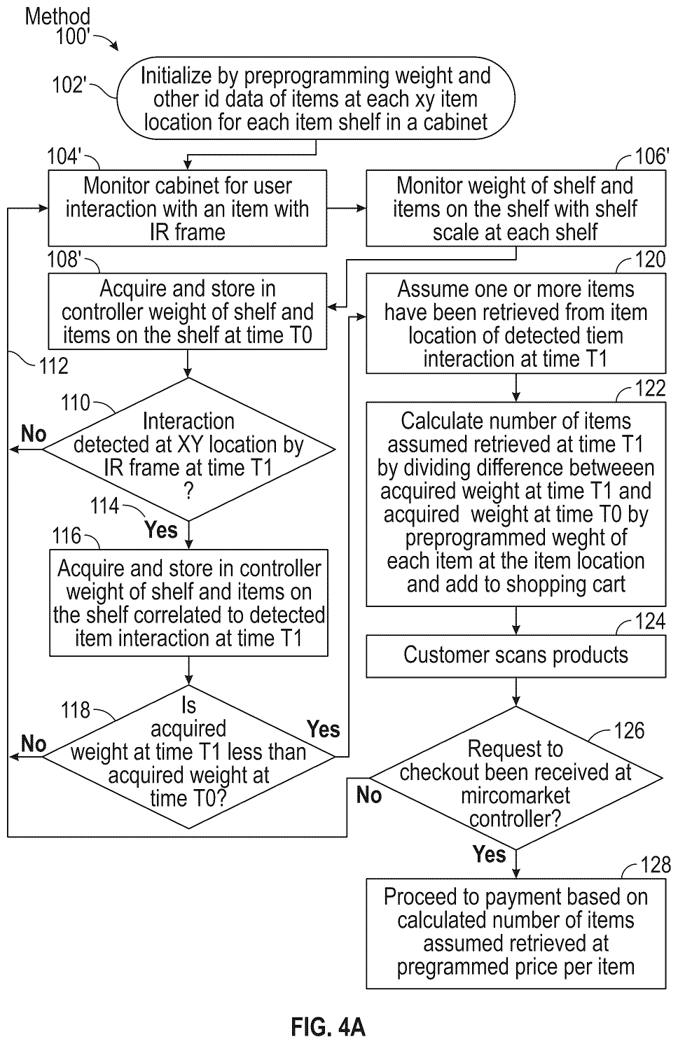

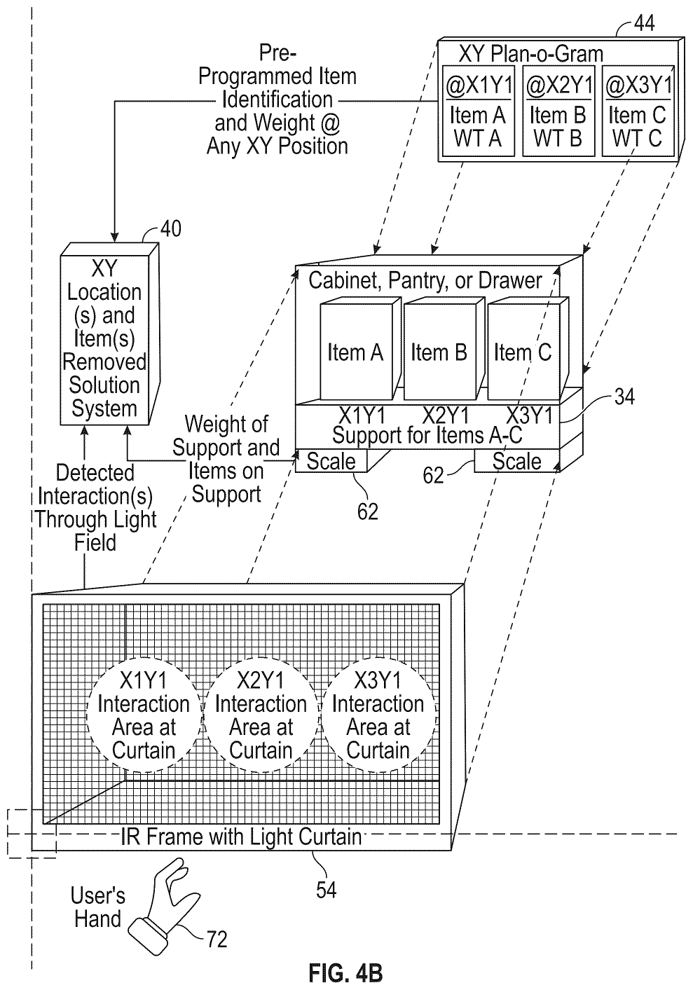

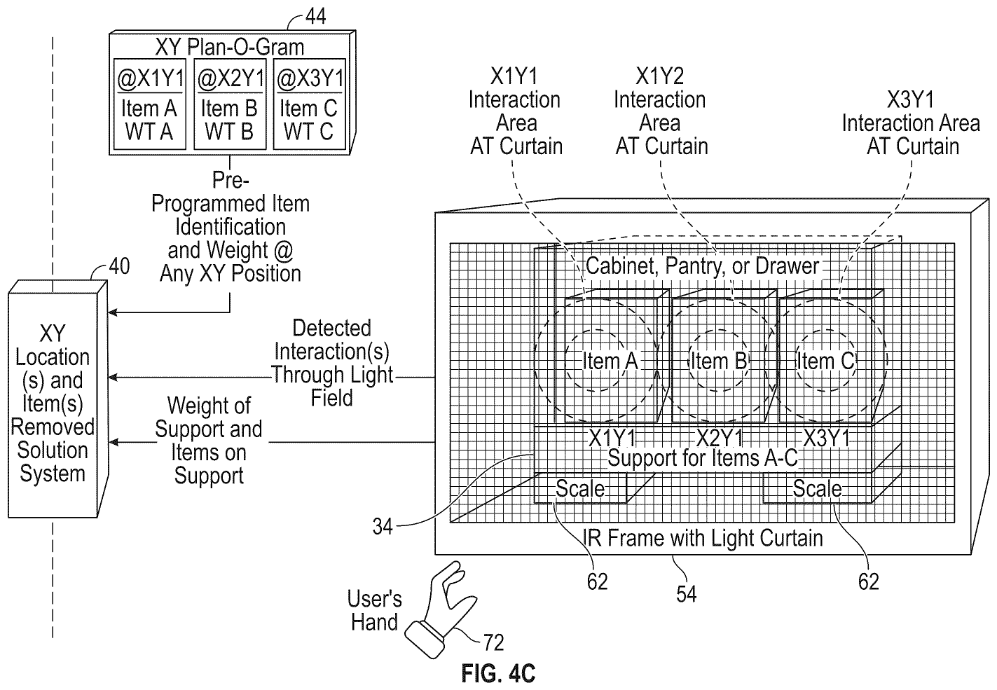

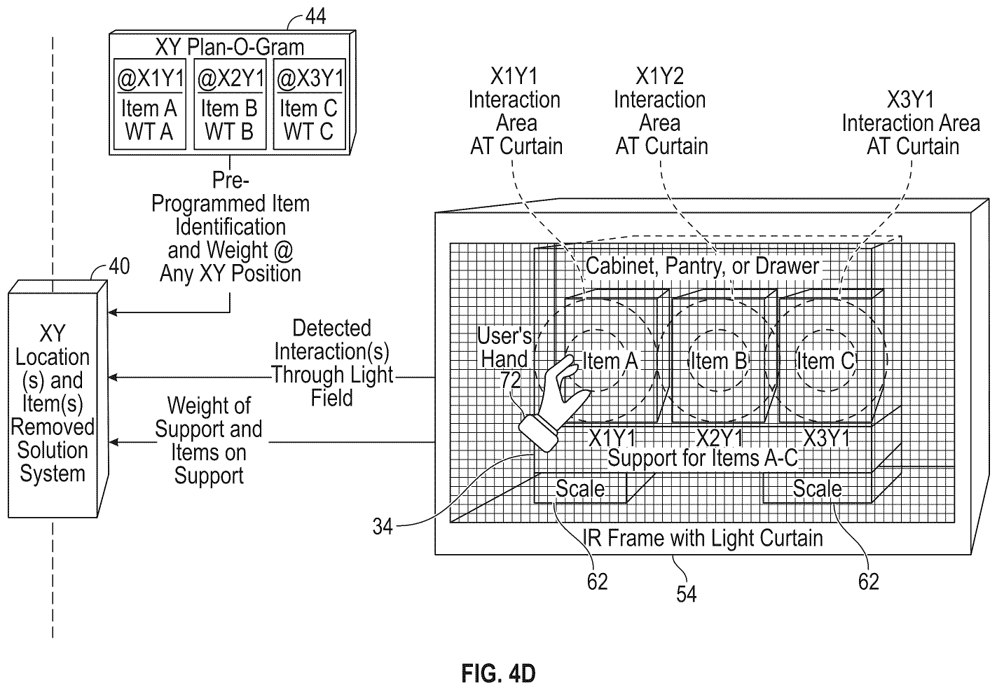

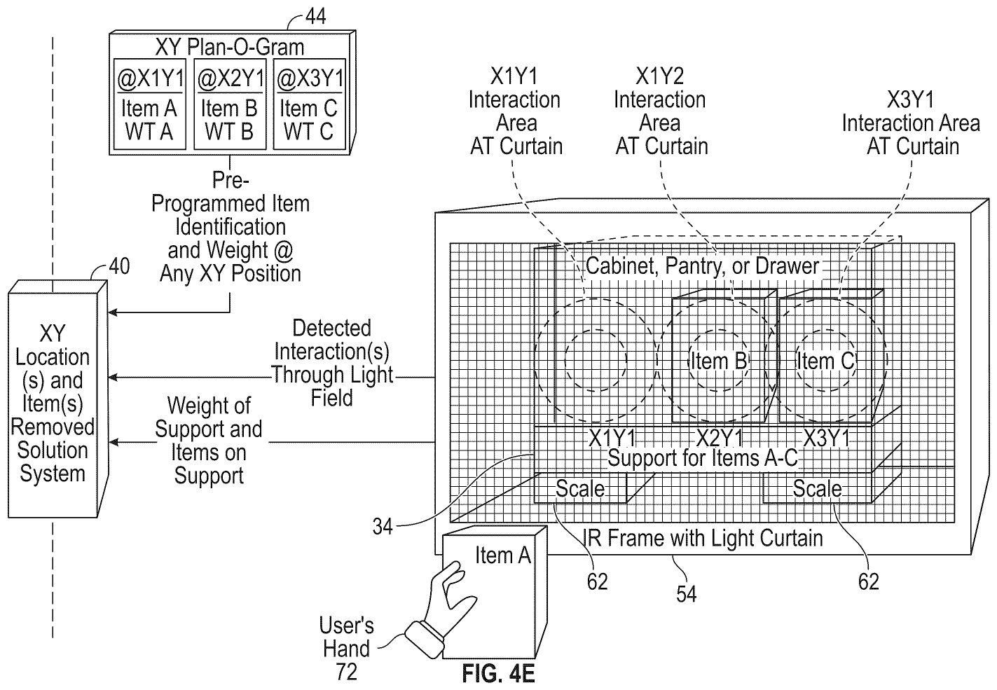

FIG. 4A illustrates but one possible method 100′ according to the invention that includes the basic paradigm of hand tracking and weight tracking of method 100. As will be appreciated, the methodology can vary according to need or desire.

At some point, there must be an initialization that correlates product ID information, including weight 31, with each XY product location 35 of the system. This can be a preprogramming of inventory in each cabinet 32 such as is well-known in the art, with the specific requirement that each XY location includes not only information about the type of product at that lane location, but also the weight of individual such products. See method step 102′. This, then, facilitates a product solution of which and how many items are retrieved for each XY product location by (a) detecting an XY product interaction and (b) detecting any change of weight indicative of removal of at least one product from that interaction location.

Again, one nonlimiting example shown in FIG. 9C. Product identification data can at least include information by which the type of product stocked at an XY location can be derived and its weight. This can be in a single database or could be some sort of digital map that links to a database with more detailed information.

After initialization, method 100′ then proceeds to monitor both interaction with an item within a photoelectric detection area (e.g., a preprogrammed XY location) (step 104′) and weight of each shelf or rack and items on each (step 106′).

This is accomplished by acquiring and storing weight of each shelf and items on the shelf at a time T0 (step 108′) then monitoring for any product interaction detected by the photoelectric subsystem 50 at time T1 resolved to one XY product location (step 110).

So long as no interaction is detected, the system keeps looping to monitor for the same (step 112).

If an interaction is detected (step 114), XY position from subsystem 50 and weight from subsystem 60 are acquired and stored, both correlated to the time T1 interaction (step 116).

A comparison of time T0 (before a detected interaction) weight to time T1 (after a detected interaction) weight is performed (step 118). If it is not less at time T1 than time T0, method 100′ can loop back to continue to monitor at step 104′. The assumption could be that a customer interacted with a product but has not retrieved it and therefore there is no charging event that has occurred.

If weight at T1 is less than at T0, and it is indicative of removal of at least one product, it is assumed that at least one item has been retrieved from the detected XY location of inner action at time T1 (step 120).

Then, the difference in weight between T0 and T1 is used to calculate the number of items removed from the XY position of interaction based on the pre-programmed weight of a single item for that location and both product identity based on XY location discernment and number of products from that XY location retrieved based on that weight difference discernment are acquired and stored (step 122). In the example of method 100′, the indication of a product interaction and retrieval could generate the addition of the number of items calculated removed from the interaction XY location to a shopping cart for the customer for that session. Other forms of storing the indication of number of items removed/retrieved from an XY interaction location are, of course, possible. One benefit of a shopping cart addition, is that a customer sometimes may want to replace one or more retrieved items before check out. The system 40 could, in reverse fashion, detect an indication of a return of one or more items to an XY location by sensing both an interaction and weight increase at that location with subsystems 50 and 60, including a calculation of how many said items have been replaced by comparing shelf weight before and after that “replacement” interaction. If the calculation is indicative of a replacement, the calculated number and type of item can be automatically removed from the customer's shopping cart.

As is conventional, at check out, the customer would proceed to scan the items intended to be purchased (step 124). The system could compare that to the cumulative products and price for each based on the pre-programmed XY information and the number of products for each XY interaction detected, to compare to what the consumer has scanned.

On request to check out (step 126), the system can direct the customer to proceed to payment (step 128) based on its discerned identity and number of products retrieved. As can be appreciated, these last steps can have variations.

One is to require payment for what the product solution system has discerned as the identity and number of all products retrieved. If the consumer disagrees, the system may force that event to conclude a checkout. This could include either charging the consumer accordingly. Alternatively, if the consumer inadvertently did not scan a detected product, it can allow the consumer to scan it to meet the calculated amount due. Other options are available according to the owner/operator's needs or desires.

Also, it is to be understood that alternative methods to the specific steps of method 100′ are possible according to designer need or desire. For example, any product interaction by penetrating the photoelectric subsystem 50 can be recorded and stored even if there is no indication any product is retrieved. This could help in mining customer cumulative data over time as to which products consumers express more interest in than others.

FIGS. 4B-E are diagrammatic illustrations of one non-limiting implementation of one or more aspects of embodiments according to the invention. This embodiment has one inventory support 34 (shelf in a cabinet or pantry or bottom of a drawer) that supports plural (here for simplicity three) inventory items A,B, and C. A weight scale 62 monitors and measures any change of weight of full support 34 and any items supported on it. Importantly, this is less complex and less expensive than having a scale at each XY inventory location on support 34. An IR frame 54 has an interior opening area sufficiently large to cover at least all three items and, when operated, generates a light energy field or curtain across that opening and has onboard light emitters and detectors that can detect and resolve any user finger or hand penetration of the field to an XY area that is at least as small as the XY area of any of the three inventory items, or at least sufficient to effectively indicate if the user's finger(s)/hand are near or at any individual one of the three inventory items. Similar to scale 62, IR frame 54 monitors more than one inventory item, thus saving complexity and/or cost of having individual item interaction sensors at each XY location on support 34. But, as indicated, this combination of techniques, when combined, allows resolution of user interaction with any individual inventory item or items, plus whether any interacted-with inventory item has been removed. This is possible even though the individual sensing techniques each monitors more than one inventory item.

In this embodiment, an inventory map or plan-o-gram 44 is preprogrammed or stored digitally and, similar to such digital maps in the vending or automated merchandising industry, has information about what inventory item should be stocked at each of the XY positions on support 34. Map 44 further includes average weight of the intended inventory type for each XY position. As will be appreciated by those skilled in the art, map 44 can include other item-specific information such as price (if relevant to the application) or other details (e.g., nutrition information if a food item, specifications if a tool bit, etc.).

As such, the set-up of FIGS. 4B-E can provide input to a component 40 that can provide both an XY position and item(s) removed solution. As can be understood by the exploded view illustration of FIG. 4B, IR frame 54 can be mounted at or near, and essentially frame, all the items on support 34. As such, any user penetration of or reach-through the light curtain of IR frame 54 allows IR frame 54 to sense and report which area of the curtain has been perturbed, and resolve it to essentially an XY location in the plane of IR frame 54. The XY plane of IR frame 54 can be pre-correlated or calibrated to the actual XY positions on support 34. As such, a detected XY perturbance of the light curtain can be assumed to indicate a user interaction with a particular inventory item actual physical space XY location even though frame 54 is spanning all three inventory items. This indication of user interaction can be reported to component 40 for processing.

Then, scale 62 will monitor total weight of support 34 and any inventory item on it. Any change of weight can be reported to component 40. Thus, frame 54 can be operably mounted to frame support 34 and all inventory item XY locations on it, connected to electrical power, and operably connected to solution component 40. Scale 62 can be operably mounted with respect to support 34 to effectively monitor weight of all inventory items supported by it, connected to electrical power, and operably connected to component 40.

As will be further appreciated with reference to FIGS. 4C-E, once the components are operably mounted and connected, use of IR light energy presents full coverage over user access to the inventory items, but is not visible to humans and does not pose a human safety risk as the light energy is basically in a plane across the opening in frame 54. And scale 62 is not obtrusive. Solution component 40 can likewise be relatively small and unobtrusive and housed in a small form factor housing (e.g. no more than an inch or two in the largest dimension).

The combination allows automatic monitoring of the following. First, there is automatic monitoring for detection of an indication of human interaction. This is possible because the XY interactions at the light curtain can be correlated to the actual physical XY locations on support 34, which in turn can be correlated to which items, and their weights, that are intended to be at each physical XY location on support 34. Second, there is automatic monitoring for detection of an indication of removal of an item. The weight sensor does so by detecting a loss of weight relative to the relevant inventory item support, where the loss of weight correlates to an inventory item.

As illustrated at FIG. 4C, in an active mode, after stocking support 34 with items according to plan-o-gram 44, the system generates the light curtain across the user access opening through frame 54 and waits for a perturbation. A perturbation, at FIG. 4D, can be reported automatically to controller 40 which can resolve the perturbation to a particular inventory item XY support position and, in turn, know its identity and weight by reference to the correlated plan-o-gram 44 XY position. Importantly, in some embodiments, the system can automatically retrieve a scale weight measurement at the moment of curtain penetration and then monitor (continuously or intermittently at short intervals) for any change of weight. If no change of weight occurs that is indicative of removal of an item (e.g., by comparing the retrieved weight to the weights of inventory preprogrammed in plan-o-gram 44), the system can simply continue to monitor. This allows a user to reach for and touch an item, and/or change to a different item (which it that occurs, frame 54 would detect and correlate it to the different inventory item). If there is free ability of a user to access and interact with an inventory item (pick it up, handle it) such as at FIG. 4E, controller 40 would detect a scale weight change indicative of the same and assume the item at that XY position has been removed. It can document the same for needed purposes. In one example, it could add a charge to the user's shopping cart if a purchased item. In another it could document removal of a tool or pharmaceutical to a pre-credentialled and pre-authorized user. In another, it can record/store removal of pantry item or items, and provide a pantry user immediate feedback about the identity and quantity of items removed, and/or track inventory to allow the pantry user to, on demand, check inventory for need for replenishment (it can also give feedback to the pantry owner if any inventory item is exhausted and needs immediate replenishment). As can be appreciated, feedback to the pantry owner can be in any of a number of ways that are known or becoming more widely used in communicating information automatically to humans. Non-limited examples is text-to-voice conversion (where the XY location, number of items retrieved, and their identity automated detected by the system and stored digitally can be converted to audible voice and played audibly to the pantry owner, which has obvious benefits to blind persons. But other communication modes are possible. Non-limiting examples are data to text on a display or communicated wirelessly to a smart phone, or just some type of sensory alarm (audible sound or flashing light), or combinations of the foregoing.

As will be appreciated, the system allows an economical and non-complex technique to indirectly solve XY position and item removal. It is indirect at least in the sense there are not individual automatic sensors at each inventory item location. The system and method disclosed herein indirectly indicates XY item location by correlation of XY perturbation of the light curtain of frame 54 to actual item XY position, with product identity being known by reference to pre-programmed plan-o-gram 44. It is also indirect in that weight change monitoring is of all inventory items on support 34 not change of weight at each inventory item XY position. And it is also indirect in the integration of the foregoing two indirect sensing techniques into an XY/item retrieved solution.

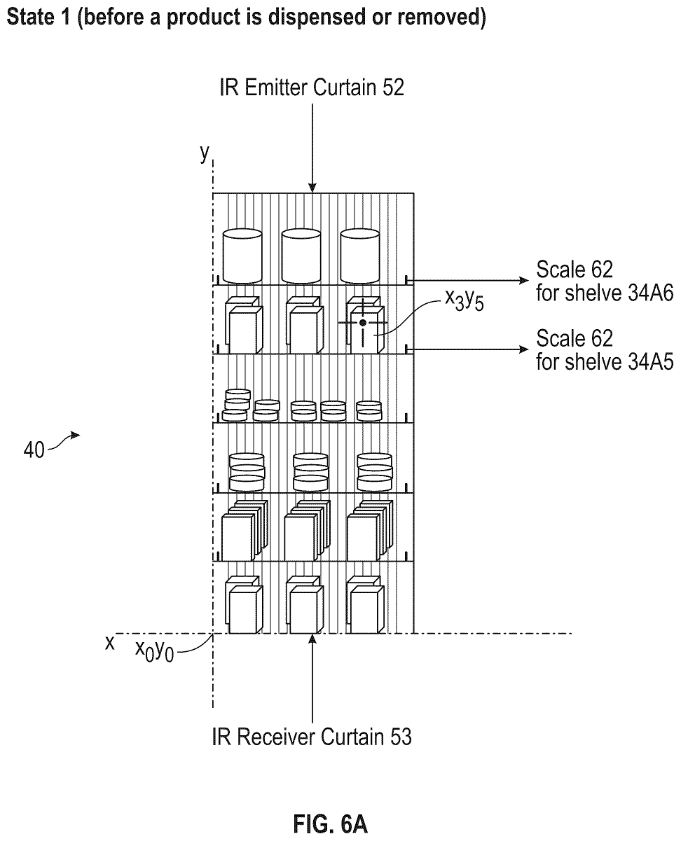

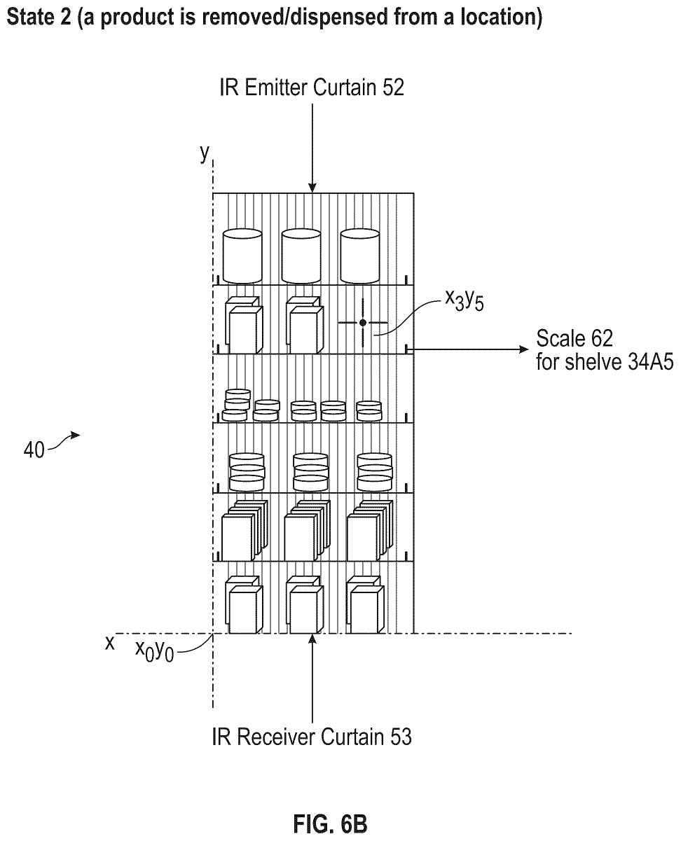

The embodiment of FIGS. 6B-E is implemented with a single support 34 and a single frame 54, where support 34 supports plural side-by-side inventory items and frame 54 frames just those items. As will be further appreciated, the basic concepts of this system can be applied in analogous manners to a variety of other set-ups and configurations. As illustrated in other figures and descriptions herein, a few non-limiting examples include multiple supports 34 each with plural items within a single frame 54. One important example is plural vertically-spaced shelves 34 within a single frame 54. Another example is multiple frames 54 each framing a single or multiple supports 34.

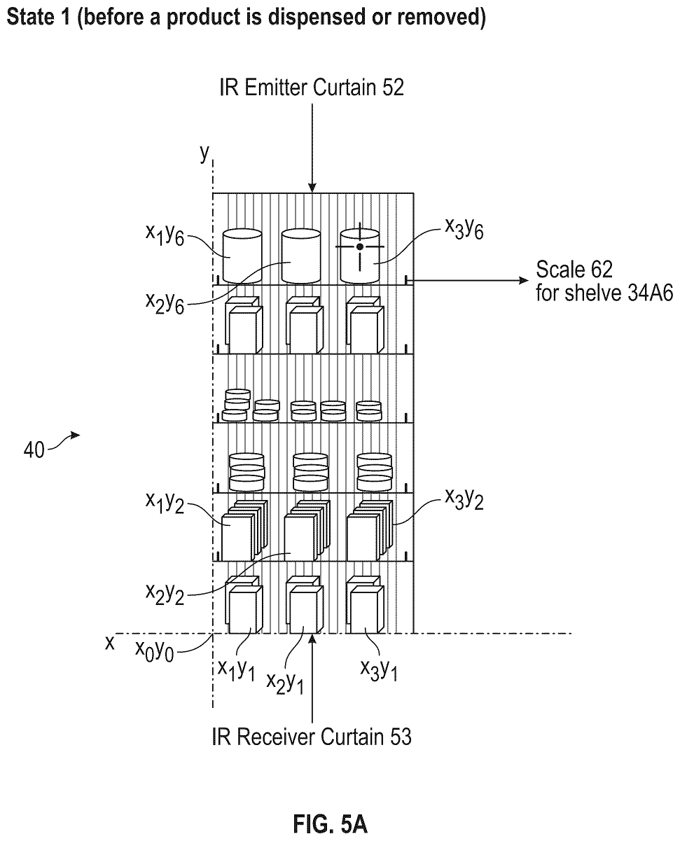

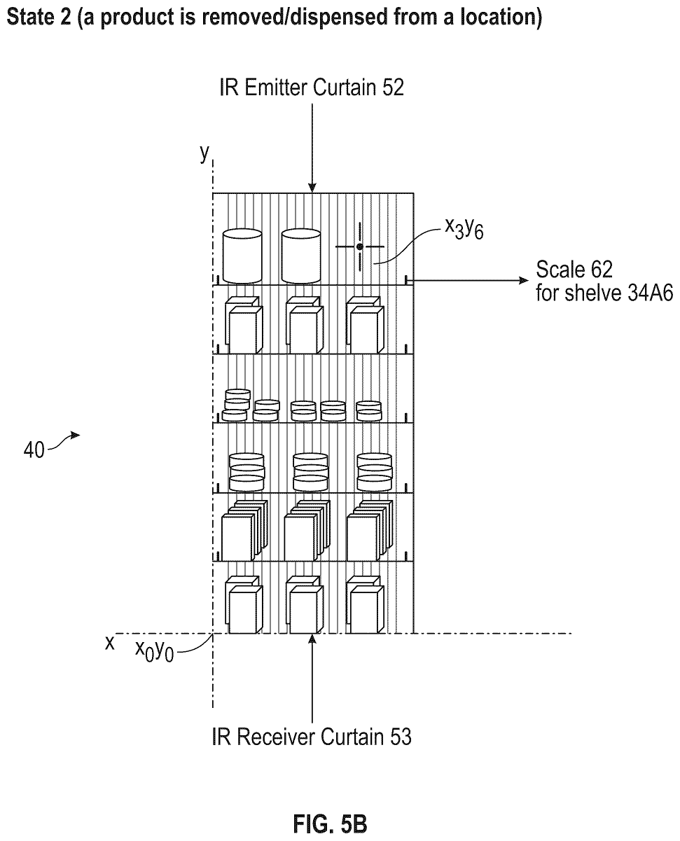

FIGS. 5A-B, 6A-B, and 7A-C are diagrammatic views simply indicating several alternative implementations of the system 40 and method 100 of FIGS. 2A-B, 3A-B and 4A-E.

As mentioned, the system 40 could be implemented on any of one or more shelves or racks that each have one or more horizontal rows or lanes of one or more items. The IR emitter receiver curtain from IR emitter and receiver sets 52-53 allows XY detection if a hand or finger penetrates or sufficiently disrupts the IR curtain to indicate if a product at that location has been interacted with.

Monitoring of weight of each shelf with scale 62 (e.g., single scale to derive per shelf weight measurement or a set of load cells or weight sensors to measurer per shelf weight) then confirms if an item or items has been removed from the shelf of the detected IR curtain interaction.

FIGS. 5A-B diagrammatically illustrate how system 40 provides a product location solution for the removal of a single item from a micro market 30. The inventory is preprogrammed so that the micro market controller 23 has a priori knowledge of the type and weight of product at each XY location. In this example there are six vertically spaced shelves 34 with three lanes of identical inventory items on each shelf. In this example, the bottom and left-most item position is X₁ Y₁ with Y₁ indicating the lowest shelf 34, and X₁ indicating the left-most lane (all correlated to an XY plane having an origin X₀ Y₀ at the lower left-hand corner). As such, the top and right-most item position is X₃ Y₆ because it is the sixth shelf 34 and the right-most lane of three lanes on that shelf. Thus, the XY item locations throughout the set-up would follow that convention. As illustrated diagrammatical in FIG. 5A, after initialization, the full set of inventory items is in place awaiting a customer session. The IR curtain from emitter and receiver sets 52/53 continuously monitors for an item interaction. The weight of each shelf 34 and the full stocked inventory on it is continuously monitored by scale 62 for each shelf. If a product interaction is detected by the IR curtain, as in access to and lifting of the item at XY location X₃ Y₆ as illustrated at FIG. 5B, the weight of shelf and remaining inventory for that shelf 34 is measured and compared to the weight prior to the detected interaction. If there is an offset that indicates the item at X₃ Y₆ has been removed, the system would log that. One example would be to place that item into the customer's shopping cart or an analogous holding list for purchase. The subsystem 50 IR curtain detects XY location. The subsystem 60 weight monitoring detects how many items from that XY location appear to have been removed. This information is an effective and economical way to inform the micro market system 30 of type and number of removals.

Statement of Invention of Embodiment of FIG. 5A-B. The concept combines a scale on a shelf and an IR curtain to determine the position a product has been taken from. Details of State 1 of this embodiment follow.

Fully stocked cabinet with 6 horizontal shelves, each at different vertical heights relative to XY plane, and each having one or more product locations Xₘ Yₙ relative to an origin X₀ Y₀ across (e.g., top shelve 6 has three product locations X₁Y₆; X₂Y₆:X₃Y₆).

Products (same or different in size, shape, type, number across or front to back) on each shelf.

Scales that sense and feedback to a processor current cumulative weight of products on each shelf.

Curtain of IR beams in vertical plane in front of products parallel to XY plane. The current can be similar to existing “vend sense” IR emitter/receiver sets. A possible alternative is a touch panel overlaid over the window or glass in front of the products, with an array of X-Y infrared LEDs and photodetector pairs around the edges to detect a disruption the pattern of the LED beams to derive exact location of the touch at least on one direction (here X or horizontal). This is based on our understanding from reference to https://www.amazon.com/Multi-Touch-Point-Infrared-Screen-Overlay/dp/B07CW9WWT5?ref_=ast_sto_dp&th=1 and our review of different types of touchscreen technology, including IR grid based.

Details about State 2 of this embodiment are as follows.

Disruption of IR curtain at a product location (such as when product is grabbed or dispensed) allows sensing of at least X value of location (by analyzing sensed reduction on IR beam intensity along Y direction).

Sensed reduction in weight at that shelf (by monitoring change in weight of all shelves) allows identification of Y value of location.

Thus, by continuously monitoring both IR current disruption and digital scales at each shelf, of the product in the upper left position on top shelf 6 is removed (as illustrated above), exact location of the removed product (e.g., X₃ Y₆) can be automatically derived by the VMC or equivalent.

Further, of location has multiple products in inventory, this allows derivation of just one or more than one is removed by analysis of shelf weight before and after.

FIGS. 6A-B illustrate, similar to FIGS. 5A-B, another example of a customer interaction, but one which removes plural items (here two original stocked items at X₃ Y₅) from the same XY location X₃ Y₅. Again, system 40 would use subsystem 50 IR curtain to detect XY location of customer interaction, and subsystem 60 to determine how many from that XY interaction location have been removed by comparing shelf weight prior to the interaction and shelf weight after divided by the preprogrammed weight of an individual product at that XY location.

Details of State 1 of this embodiment follow.

Fully stocked cabinet with 6 horizontal shelves, each at different vertical heights relative to XY plane, and each having one or more product locations Xₘ Yₙ relative to an origin X₀ Y₀ across (e.g., top shelve 6 has three product locations X₁Y₆; X₂Y₆:X₃Y₆).

Products (same or different in size, shape, type, number across or front to back) on each shelf.

Scales that sense and feedback to a processor current cumulative weight of products on each shelf.

Curtain of IR beams in vertical plane in front of products parallel to XY plane. The current can be similar to existing “vend sense” IR emitter/receiver sets. A possible alternative is a touch panel overlaid over the window or glass in front of the products, with an array of X-Y infrared LEDs and photodetector pairs around the edges to detect a disruption the pattern of the LED beams to derive exact location of the touch at least on one direction (here X or horizontal). This is based on our understanding from reference to https://www.amazon.com/Multi-Touch-Point-Infrared-Screen-Overlay/dp/B07CW9WWT5?ref_=ast_sto_dp&th=1 and our review of different types of touchscreen technology, including IR grid based.

Details of State 2 of this embodiment follow.

Disruption of IR curtain at a product location (such as when product is grabbed or dispensed) allows sensing of at least X value of location (by analyzing sensed reduction on IR beam intensity along Y direction).

Sensed reduction in weight at that shelf (by monitoring change in weight of all shelves) allows identification of Y value of location.

Thus, by continuously monitoring both IR current disruption and digital scales at each shelf, of the product in the upper left position on top shelf 6 is removed (as illustrated above), exact location of the removed product (e.g., X₃ Y₆) can be automatically derived by the VMC or equivalent.

Further, of location has multiple products in inventory, this allows derivation of just one or more than one is removed by analysis of shelf weight before and after.

Details of an alternative embodiment follow.

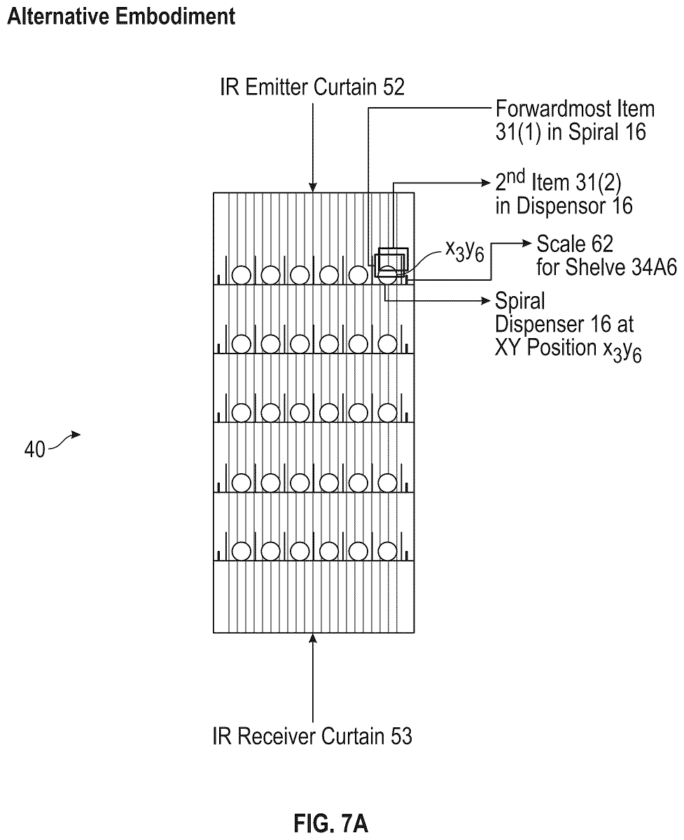

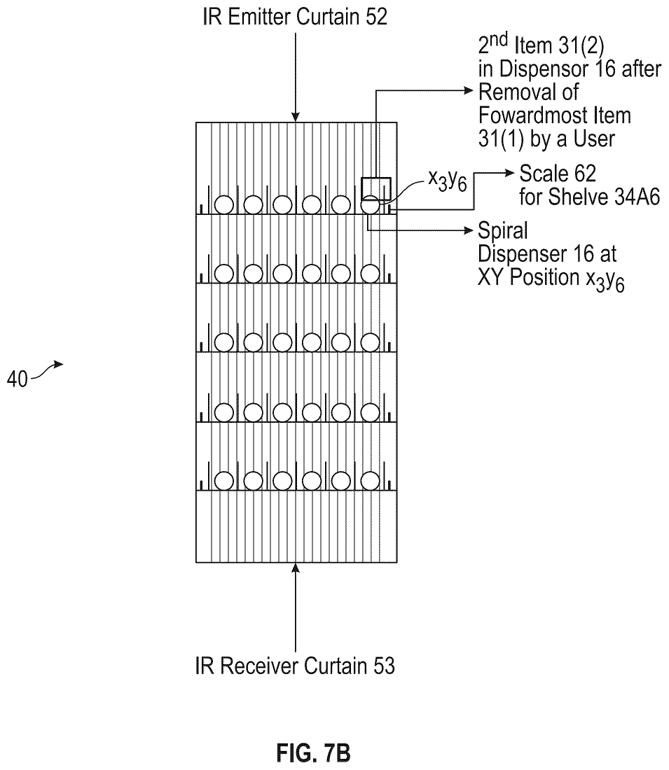

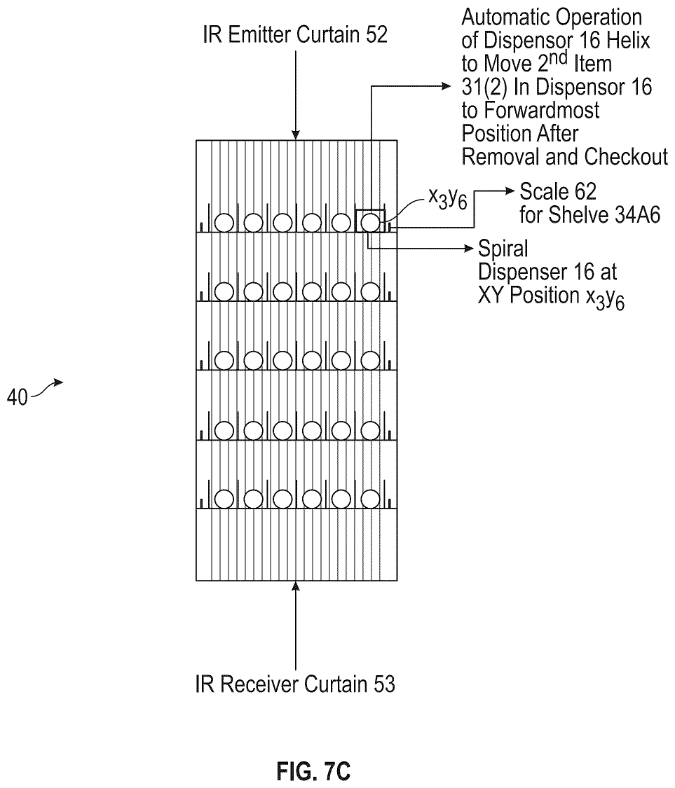

FIGS. 7A-C show a slight variation from FIGS. 5A-B or FIGS. 6A-B. Like FIGS. 5A-B or FIGS. 6A-B, the IR emitter curtain receiver set up for XY interaction detection 50 and scale weight comparison prior and after interaction 60 can give a position solution and number of products retrieved. But in this FIGS. 7A-C example, there are automated product dispensers 16 positioned at each lane on each shelf. Once a product retrieval, including number of products from that XY location, are discerned by the system 40, the system 40 can then be programmed to automatically advance the dispenser 16 to move the next available product in the XY lane up to the front for the next customer session. If system 40 detects just one item removal, dispenser 16 advances to bring the 2^{nd} item up to the front. If the system 40 detects two item removals, it advances dispenser 16 sufficient to bring a 3^{rd} prior item to the front, and so on. As is well-know to those skilled in this technical field, vending machines have a variety of different types of dispensers that can hold a lane of inventory, and by electro-mechanical actuators, be instructed by a vending machine controller (VMC) to advance one, two, or more products forward. This can be programmed into position solution controller 43 or another programmable controller in a similar manner to response to system 40 detection of one or more items removed from an XY location. Once a product retrieval, including number of products from that XY location, are discerned by the system 40, the system 40 can then be programmed to automatically advance the dispenser to move the next available product in the XY lane up to the front for the next customer session. Thus, in the situation of customer access to an inventory to enable a customer to interact with, remove, or replace, an item, use of the system 40 according to the invention, including detection of number of products retrieved during a session, allows movement of the inventory in the lane up to the front for the next customer.

An example of a dispenser 16 is a helical automated dispenser, such as is well known in the vending machine art. See, e.g., U.S. Pat. No. 7,564,222, incorporated by reference herein. For example, if a consumer removes one bag of chips at the front of the lane in a first customer section with a helical dispenser 16 loaded with a lane or row of such chip bags, at some point (e.g. after a customer indicates check out, or after a customer scans that type of bag of chips), the dispenser 16 is automatically instructed by controller 43 (or the micro market controller 23) to rotate to move the next or second potato bag to the very front of the lane. If the consumer had removed two bags, the system automatically rotates the helix to move the third bag to the front.

### 4.3 Options and alternatives

As will be appreciated from the foregoing, the system and method of the present invention can be implemented in a variety of ways.

### 4.3.1 XY Position Sensors/Hand Trackers

As indicated herein, different XY position resolvers or hand tracking techniques are possible. A main benefit is that they monitor a set of inventory items or array at the same time, and do not need to identify the product or inventory item at each location from its sensing technique. Its solution is a human/hand interaction at any such location.

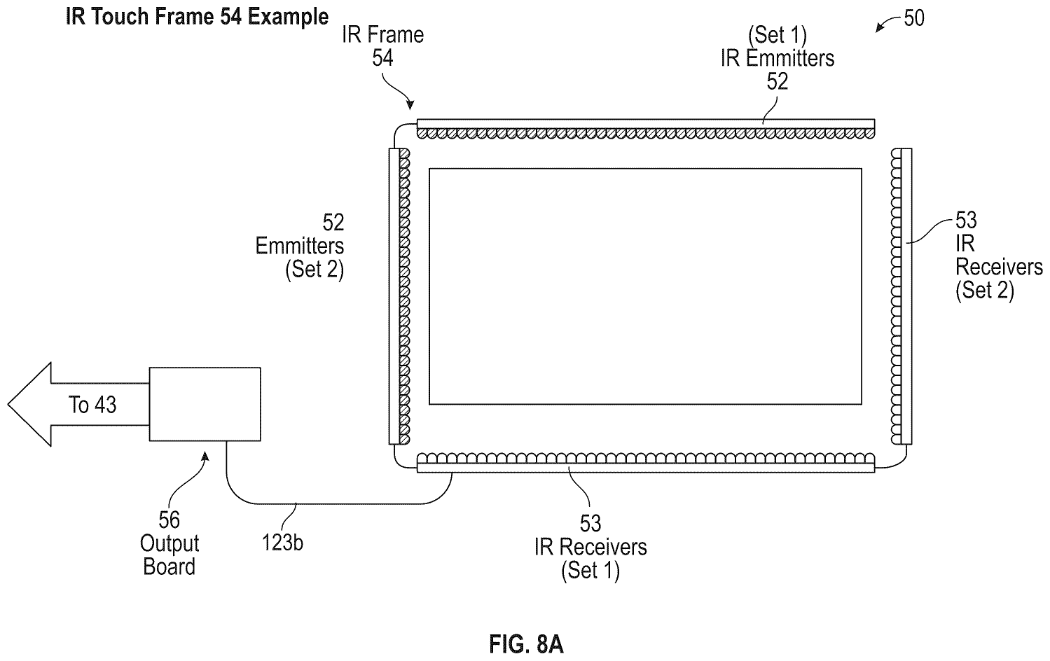

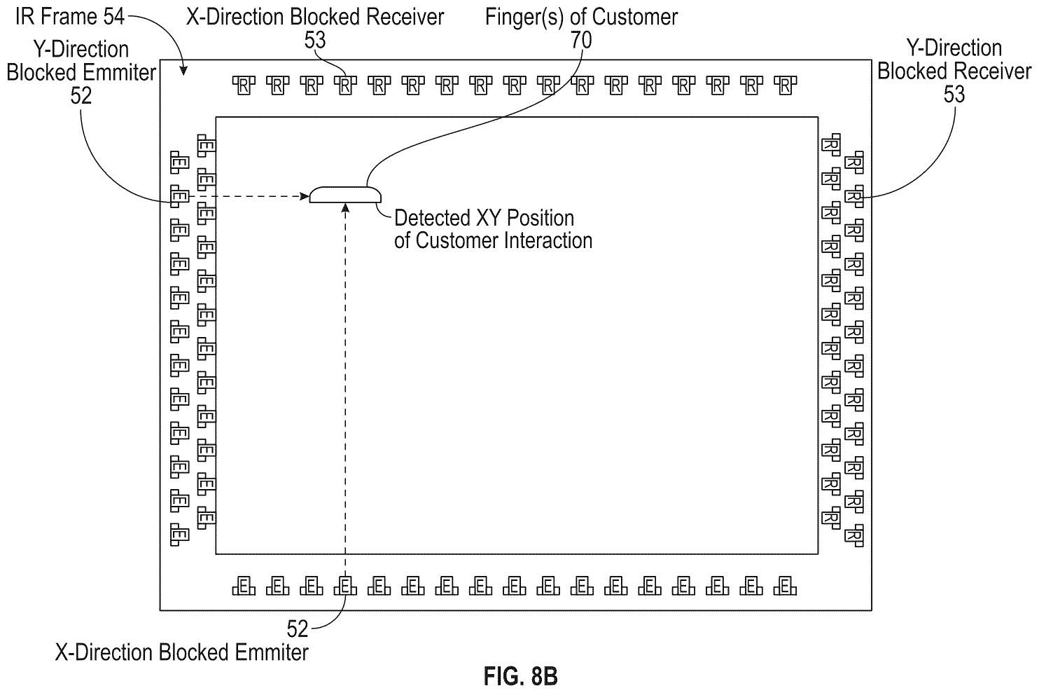

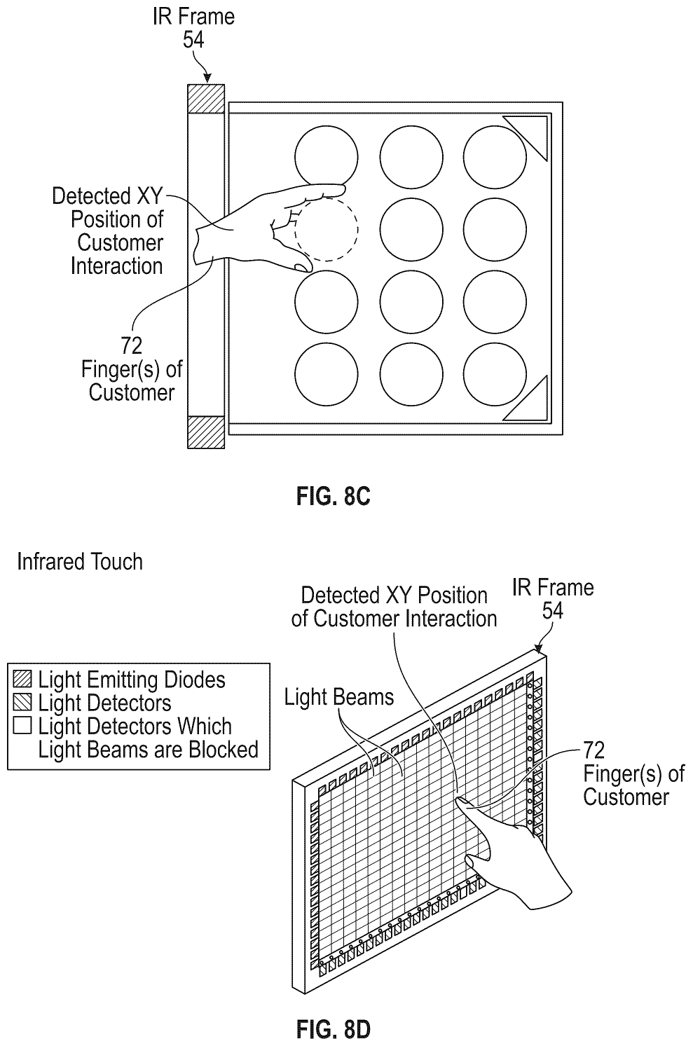

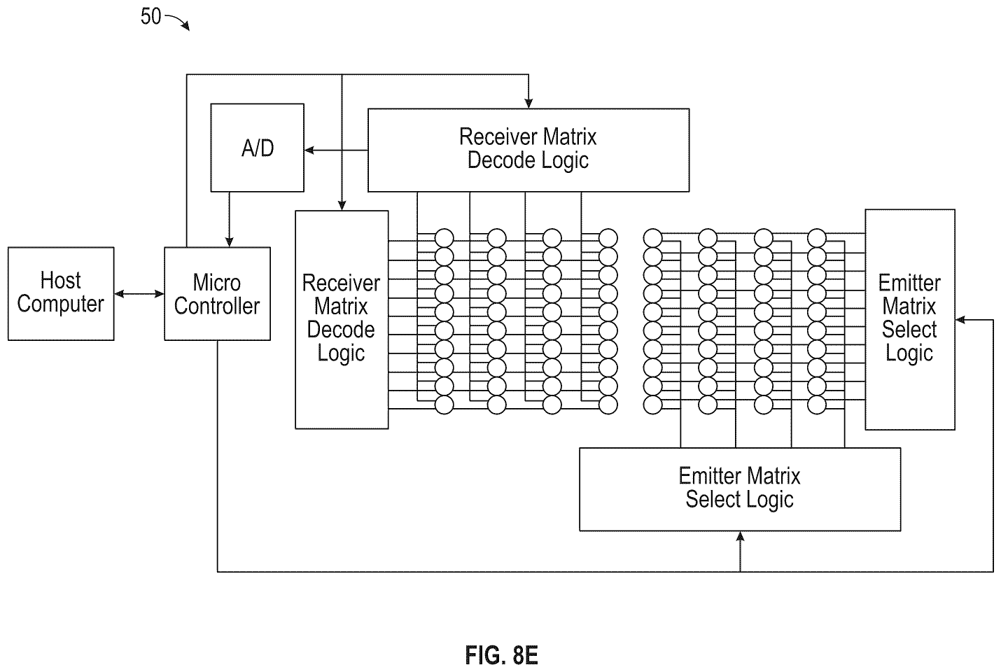

There are different ways to use photoelectric techniques to discern XY position relative to an area. One example is shown in FIGS. 8A-E and FIGS. 13 and 14. Operation of an IR frame subsystem can be seen in the discussion of U.S. Pat. No. 9,013,450 B1, which is incorporated by reference herein. As can be seen in the set-up of that patent, a set of IR emitters 52A can be aligned in a frame on an opposite side of an open area to a row of IR detectors 53A. Similarly, IR emitters 52A can be aligned along orthogonal axes to detectors 53B. As shown in FIG. 8A, emitter detector sets 52A, 53A can be parallel to a central vertical y-axis in the open area whereas sets 52B, 53B can be on opposite sides of the central horizontal X axis. As shown in FIGS. 8B-D, a user's finger or hand inserted through the plane of that IR curtain would block emitter along that Y direction and the emitter along an X direction.

As shown at FIG. 8E, converters can allow discernment of disruption of the IR curtain with sufficient resolution to a specific XY location correlated to XY locations in a relative to the one or more shelves with items of inventory. That derived XY location can be communicated to a microcontroller that can then be utilized with the position solution controller to discern XY position of interaction. FIG. 8E is taken from U.S. Pat. No. 9,013,450.

The foregoing provide descriptions of how to install and use IR frame type XY position sensing subsystems. Other types and techniques can be utilized. For example, in FIG. 13, a frame with complementary sets of IR beam emitters and receivers on opposite sides essentially create a curtain of light across the area of the frame and can sense location of interaction within the plane of the frame by sensing disruption of the light curtain at the intersection of one or several emitted IR beams from X and Y directions. In some embodiments, there can be a pane of glass or transparent material across the frame. In others, there is no material across the frame, allowing for reach-through the frame. In either case, the disruption of a combination of X direction beam(s) and Y direction beam(s) allows resolution to within less than one inch or so of XY interaction relative to the axes of the frame. One commercially available example is a GreenTouch® TB Series 27 to 98 inch infrared touch frame available from GreenTouch Technology Co, Ltd. of China. It has sets of IR emitters and detectors in a 10 mm thick aluminum frame of a variety of X and Y dimensions that can be mounted by fasteners. It has a USB plug and play configuration (Windows, Android, Linux, Mac), touch resolution of 32768*32768 (7 mm dia. and greater), and 5 VDC operation and connection 55 to electrical power. As such, it can be appreciated that an appropriate overall sized frame could be placed to surround or frame an inventory to be accessed, and easily integrated into the system to sense an object (e.g., human finger or hand) penetrating the light curtain, and resolve its XY location to within the frames resolution capability. And it will be appreciated such a frame can be mounted and operate in any orientation relative to earth, e.g., its XY plane vertical (such as over the front face of a plurality of vertically spaced horizontal shelves each with inventory products), its XY plan horizontal); its XY plane horizontal (such as over the top of a drawer with plural compartments); or any angle oblique to vertical or horizontal. Another commercially available example is Model CYS-24-p10 (24 inch X width but available in different XY sizes) Multi-Touch IR Touch Frame from Chengying of China. See FIG. 14.

As will be appreciated by those skilled in this technical art, different XY position IR frame resolutions are possible, depending on the number of IR emitters and detectors and their specifications, the beam patterns of the emitters, and the software that interprets the detectors operation. In one example, for a 60-inch Y-axis height IR frame, resolution down to two-thousandths of an inch is possible. Typically, less resolution would be operative in the case of most micro market inventory items, which usually are at least an inch wide. The designer can select an IR frame or other photo-optical XY position detector subsystem according to need or desire.

As will be appreciated, system 40 can be configured/programmed to anticipate and resolve XY position adequately even though it is possible a customer may move to an item from a side of the item, or slide to one side or the other when picking it up. As will be appreciated by those skilled in this technical art, the actual XY location of the stored item on the shelf or rack can be inferred, even if the system 50 tracks activity in adjacent XY locations. One such technique is averaging, in the sense that system 50 would designate the XY location to that which, on average, sees the most interaction. Most times in a micro market set-up, customer interaction will be with the front-most item and optical detection of interaction will be predominantly, if not all, at that XY location as opposed to locations on either side.

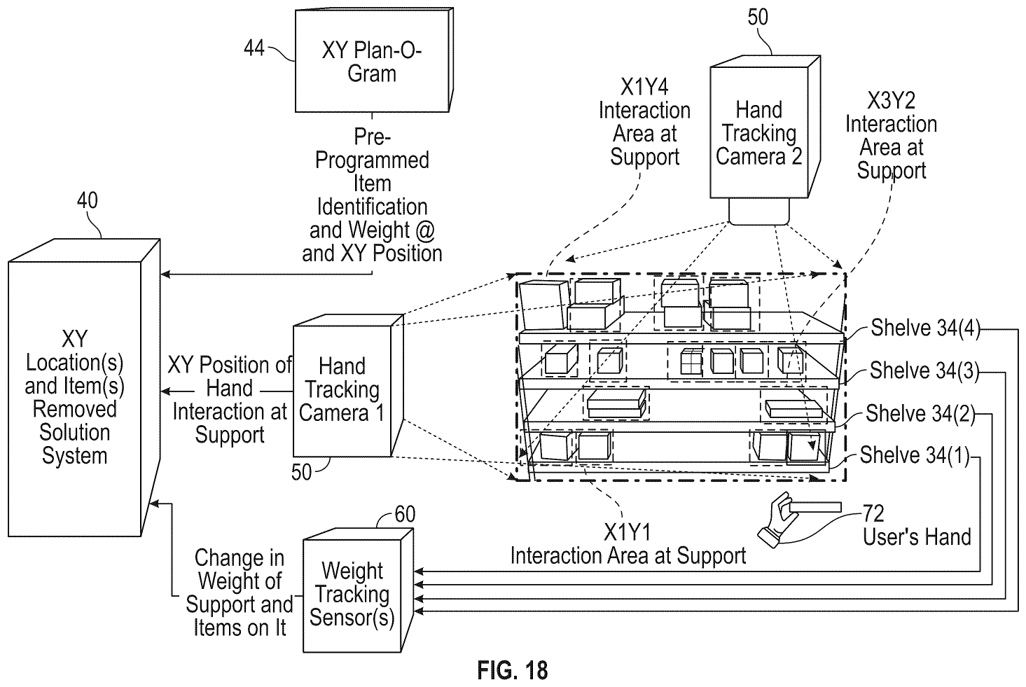

FIG. 18 illustrates use of one or more digital cameras as an alternative hand tracking technique instead of an IR frame, as one other non-limiting example. The technology of correlating camera space coordinates to physical space, and then resolving XY camera space location of an object in camera space to actual physical space XY location are known. Examples include U.S. Pat. Nos. 11,403,780 and 9,325,969 which are incorporated by reference herein. For example, a digital camera can be mounted to have a field of view that includes the frontal XY plane of a micro-market or other inventory of supported items. Its XY camera space can be correlated to each item in inventory by an XY area for each. Then, camera vision recognition can recognize a hand and track the hand through its camera space—which is correlated to actual XY physical space. The correlation can resolve by averaging or other techniques to indicate a specific XY inventory location. Two cameras can be used, each having a field of view of the whole inventory and one camera can resolve X position, and the other Y position by separate calibration of each relevant to each axis, and the values then combined to resolve both X and Y position of a hand. Again, these techniques are similar to how the physical location of a computer mouse, sensed by its roller ball rotation relative to some a priori reference point, allows a computer to correlate cursor position on a computer display to physical mouse position at any time, including tracking the mouse physical movement in real time. Other techniques of indirectly resolving physical space movement and position relative a plane can be used.

Another possible XY location resolver would be a touch screen over the frontal plane of the inventory items. In some circumstances, a user could touch any location on the closed touch screen over the inventory that corresponds with an XY inventory location of interest. If the front door is not locked, the user could open the door and remove the indicated item, and the weight tracking subsystem 60 would inform the overall system 40 if it is indicated that one or more items from that location have been removed. If a locked front, a dispenser can be activated to dispense one or more of the items indicated by the XY touch of the touchscreen, and the weight sensor 60 would report how many items from that location have been dispensed.

### 4.3.2 Shelf Weight Monitoring

FIGS. 9A-E show one example of a weight sensing subsystem 60. As shown in FIGS. 9A-B, load cells sets 62 (here four at each corner of each shelf 34—one the front two are visible in this figure) are operatively installed between a shelf 34 and its supporting structure (here vertical brackets on the inside of cabinet 32A). Each set monitors total weight of shelf and any items on the shelf. As shown in FIG. 9C, the preprogrammed inventory for each X position on the shelf includes weight per item of that lane of inventory. As shown in FIG. 9D, A to D converters for each set of load cells 62A1, 62A2, 62A3, and 62A4 (four load cells per set per shelf 34(1), 34(2), 34(3), and 34(4), respectively) can continuously provide the position solution controller 43 digital quantification of combined weight of its shelf and any items on that shelf. Thus, the system can be programmed such that any detected XY disruption resolved to an XY location at a shelf can be correlated to a change of weight at that shelf indicative of one or more products from that XY location having been retrieved/removed by retrieving stored weight measurement before the detected interaction with a weight measurement after the interaction. As will be appreciated, load sensors and other commercially-available weight sensors can be used. In some embodiments, one weight sensor is placed at each of four corners of a supporting surface. But in others, three, two, and sometimes just one weight sensor might be used if it is effective to sense with sufficient resolution change of weight of the lightest inventory item. Sensors with resolution down to on the order of 1 ounce are relatively economical. Some sensors can resolve to even smaller weight differences and, if needed or desired, can be used.

U.S. Pat. Nos. 10,614,415 B1 and 10,466,095, incorporate by reference herein, provide descriptions of how to install and use load cells to measure shelf and shelf contents weight. Other types of weight sensing techniques can be utilized.

FIG. 9E, in combination with FIG. 9B and others, indicates that position solution system 40 can be used in a variety of situations. Some displays would have one item per XY position. More typical is plural of the same items at each lane or row of a shelf. It is possible that the same items at each XY position could be placed in a series along front to back of the lane or row (as in FIG. 9B). But is possible they could be stacked vertically (see shelf 34(2) and some of the items on shelf 34(4) in FIG. 9E). This is because the weight monitoring subsystem 60 of the position solution system 40 is just looking for difference in weight of the whole shelf and any items on it before and after detected customer interaction with an XY position. Whether the customer takes one stacked item or more for a stacked XY location, system 40 would discern how many were removed.

As will be appreciated by those skilled in this technical art, different weight monitoring resolutions possible, depending on the type and specifications of a weight sensor, how it is mounted relative to a shelf or rack, and the software that interprets the detectors operation. In one example, resolution down to one ounce (or even less). Typically, resolution down to one ounce would be operative in the case of most micro market inventory items, which usually are each at least an ounce in weight. The designer can select a digital scale, load cell, or other weight sensor with sufficient resolution according to need or desire.

### 4.3.3 Inter-Operability With Other Components

Still further, FIG. 10 diagrammatically indicates how a system 40 according to the invention can be used with a larger system of multiple customer accessible machines, micro markets, or inventory displays, whether physically near each other or at widely diverse areas. For example, a single owner operator could have micro markets in a variety of locations in a city, state or even nationwide and communicate them all together for accounting, marketing, or other purposes.

FIGS. 11 shows other possible optional features. This embodiment according to one or more aspects of the invention is applied to micro market with added display screen 46 to show item description/price or other information when customer points through the IR curtain to item; and optional speaker to convert information into speech through speaker 48 for hearing impaired)

A digital display 46 could be mounted on or built into one or more cabinets 32 and connected to the position solution controller 43 right at each cabinet, and provide real-time information for a user as to which item or items he or she has interacted with and/or then actually retrieved. This could help the user understand what the system believes have been retrieved to get more consistency between customer interaction detection and check out. The display 46 could also display such things as preprogrammed information about the product to help the user decide on selection. Examples would be nutritional information, ingredients such as relative to allergies, price, etc.

Another possible option is speaker 48 added to the system and operatively connected to the position solution controller 43 or the micro market controller 23 and a text to speech conversion software to audibly play the information that is on display 46. This can benefit visually-impaired persons.

### 4.3.4 Networking and Communications

Of course, system 40 can be retrofitted to existing racks, shelves, cabinets, displays, or other managed inventories, or installed as original equipment, and be effectively and efficiently communicated with other devices, such as a vending machine controller, a micro market controller, or other devices and networks. FIG. 10 illustrates some examples, including the ability to communicate with personal digital or smart devices, such as smart phones and tablets.

U.S. Pat. No. 11,526,843, incorporated by reference herein, discusses other variations on such components, communications, and networking.

As will be appreciated, the photo-electric interaction detection subsystem 50 and weight monitoring subsystem 60 for each set of shelves can be connected to a position solution controller 43 for just that set of shelves, and communicate continuously with another controller (e.g. micro market controller 23) which can control each customer's shopping cart or other on-going accounting of items indicated to have been retrieved. A similar set of 50 and 60 for every other set of shelves could likewise each have its own position solution controller 43, and communicate with another central controller (like micro market controller 23).

Alternatively, each set 50/60 of one or more sets 50/60 could communicate with one position solutions controller 43, which could then communicate to the controller 23 for the micro market.

### 4.3.5 Types of Shelves/Racks/Cabinets

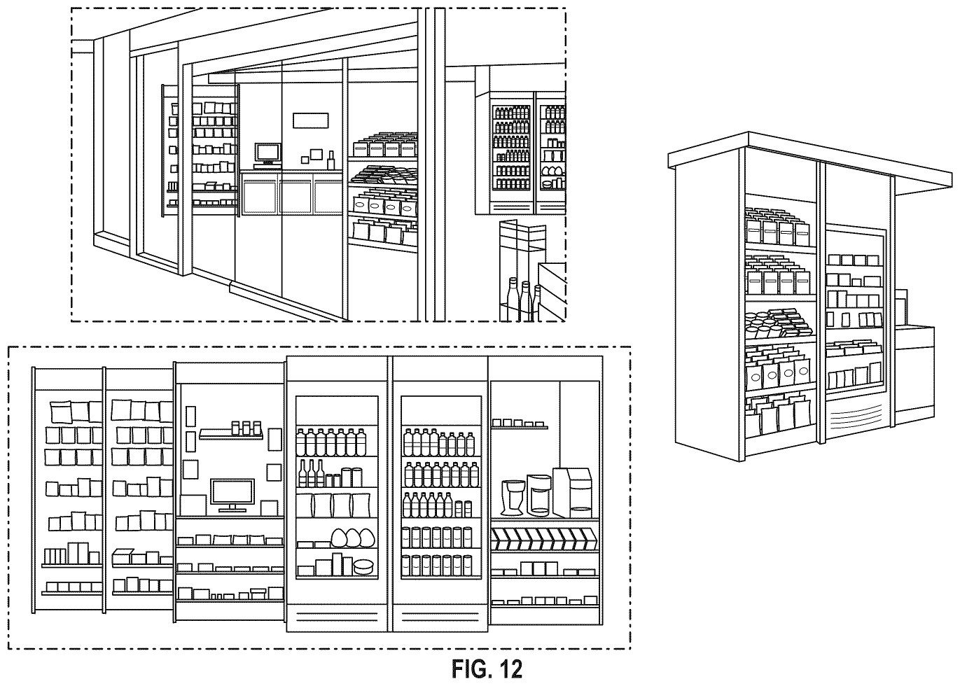

As mentioned previously, the system can be applied to almost any shelf or rack that supports at least one item with which someone may interact with and retrieve items. Micro markets have been described above. See the figures, including FIG. 12. There are other configurations where simply monitoring and reporting an indication of interaction and retrieval could be utilized. One example could be a shelf or rack with safety helmets at spaced apart lateral positions. Such a system could report to a person monitoring whether or not a sufficient number of safety helmets have been retrieved for a given work area for work crew.

Options in FIG. 12 include the following.

System 40 with coolers, with and without locks, cabinets with and without locks or shelf/racks.

Various payment solutions and inventory control and marketing data collection communication.

The upper image of FIG. 12 shows a Micro Market with open racks and closed displays, but requires prepayment step to open lockable entrance door to room.

The lower two images of FIG. 12 shows open to public exposed racks and cooler cabinets with checkout/payment station.

Other examples are many and within the skill of those skilled in the art.

On the other hand, implementation in a wide variety of automated merchandising contexts is also possible. The benefits regarding micro markets have been discussed above. It could be integrated even in a situation where cabinets with inventory have locked doors. It could be that the user is forced to pay or swipe a card to check out a given type and number of inventory before the door is unlocked and that pre-determined type and number is stored regardless of the type and number removed by the user. This could help simply track at least intended usage of type and number of such items even if the number actually removed differs.

More particularly, use with automatically lockable doors could be configured such that, if at checkout, less items are scanned than derived from the position solution system 40, the door could be automatically locked to prevent any other removals and a check out required even if there is an offset indicated.

Other paradigms are possible according to need or desire.

FIG. 12 illustrates some examples of different micro-market set-ups, some with a room door into an enclosed room that has a variety of opens racks and cabinets with doors with inventory that can be purchased. A display and payment solution may be outside the room and require at least a credit/debit card swipe to unlock the entrance; and then have a checkout scan and pay station inside or outside. Other set-ups are publicly-accessible (as in a hallway) and have open or cabineted inventories.

In some situations, the invention may be used simply with an open shelf or set of vertically spaced shelves (or rack/racks) to give an XY solution for an item location interacted with on any shelf within the sensing area of the photoelectric XY position sensing subsystem, and determine it has been removed from a change of shelf weight from the shelf weight sensing subsystem. This could produce an XY position solution for any item removed for, for example, simply generating a digital stored record (or a displayed indication or alarm or similar) that an item or items has/have been removed from that interacted location. There could be situations where an automatic detection of removal of one or more items alone is desired. This could be beneficial, inter alia, to keep track of inventory on the shelf or shelves (or what has been removed at any time) that are exposed, regardless of a lockable or unlockable cabinet or payment/checkout station. The XY position solution could be communicated to another digital device and displayed, alarmed, or stored. This embodiment could also automatically sense when and how many items are added back to any XY location.

In some situations, the invention may be used with a closed cabinet or display, whether always locked to customers (like a vending machine) or not (non-lockable, always unlocked, or automatically unlocked and locked depending on stage of a customer session). For example, an IR frame or other XY position detector activated by touch or pointing could be installed on the outer side of the closed front of the display or cabinet, but have a sensing area that covers at least some of the XY plane of that closed front. If the closed front of the cabinet or display is transparent so that the customer can see the inventory of products on the shelf/rack or set of shelves/racks inside the cabinet or display, an open frame XY position sensing subsystem on the outside of the closed but transparent cabinet front allows the customer to merely point through the frame towards an inventory item. Even though the customer cannot reach or touch the item, the XY position detection subsystem detects and stores the XY position correlated to the finger point (e.g., could add the item to a shopping cart or to a “selected item(s)” similar to a keypad selection on a vending machine). In some cases, the XY position detection subsystem could itself be a transparent panel that can be installed over the transparent front of the cabinet. The XY detection transparent panel (e.g. like a touch screen or with sets of photoelectric (IR) emitter and receiver sets around the outside) would similarly allow a customer to see items in the cabinet and point to one; and the touch screen or closed front photo electric XY position detector would add the item at the pointed-to location to the shopping cart. In both of the foregoing cases, the closed front of the cabinet is transparent so the customer can see the available items for possible selection, and the XY positioning system installs on the outside of that transparent cabinet front and also allows the customer to see the available items; but the XY position detection subsystem could have an open space through which a finger of hand passes until blocked by the transparent front of the cabinet, or could have a closed but transparent front that detects a finger point by photoelectric technique or by touchscreen detection. Although these embodiments do not allow the customer to touch or pick up an item of interest, it does allow visual sight of the actual items. As discussed with regard to FIG. 11, an option would be to have an added display and/or speaker that could display or announce details about a product pointed-at (e.g., price, nutritional details, ingredients, etc.) to give the customer more information. In some embodiments, the cabinet may have a closed and non-transparent front. Some type of graphic representation (e.g., pictures of actual items or other) could be placed in the XY plane of the non-transparent front that correlates with each preprogrammed XY item position of items in inventory inside the cabinet. The customer then sees a representation of all inventory items in the cabinet, and can point at one of interest, which would be detected by the XY position detection subsystem on the outside of the front of the cabinet, and that pointed-to item added to the shopping cart. In a still further embodiment, if the XY position detection subsystem has a closed front panel, the graphic representation of items in the display can be removably added to that panel.

In the above embodiments, once the XY position detection subsystem detects a customer point, there could be instructions that one point will add one item to the shopping cart, two points at the same location will add two to the shopping cart, etc., or there could be a human-machine interface that would allow a touch to indicate item and then entry of number desired from that location. Then, if the shelf weight detection subsystem indicates one or more selected items have been removed (if the customer can access them manually) or dispensed (if the system then operates a dispenser to dispense the number of items selected from that location), the system produces an XY position solution for each such customer interaction. This solution can automatically calculate the amount due or otherwise store or use the solution. As can be appreciated, if the closed front of the display or cabinet is transparent, the customer can visually see an item of interest and point to its XY location. If the XY position detection subsystem has an open area that detects a finger or hand that passes its XY sensing plane (as with FIG. 8C), or touches a closed panel across the XY position detector subsystem, an XY position solution can be automatically calculated by correlating the detected XY plane “touch” location with the XY position sensing subsystem (e.g. if the XY position detection subsystem has a closed transparent area that detects a finger touch at or near that surface, which is its XY sensing plane; as in touching a touch screen). FIG. 8C is taken from U.S. Pat. No. 11,526,643, which is incorporated by reference in its entirety.

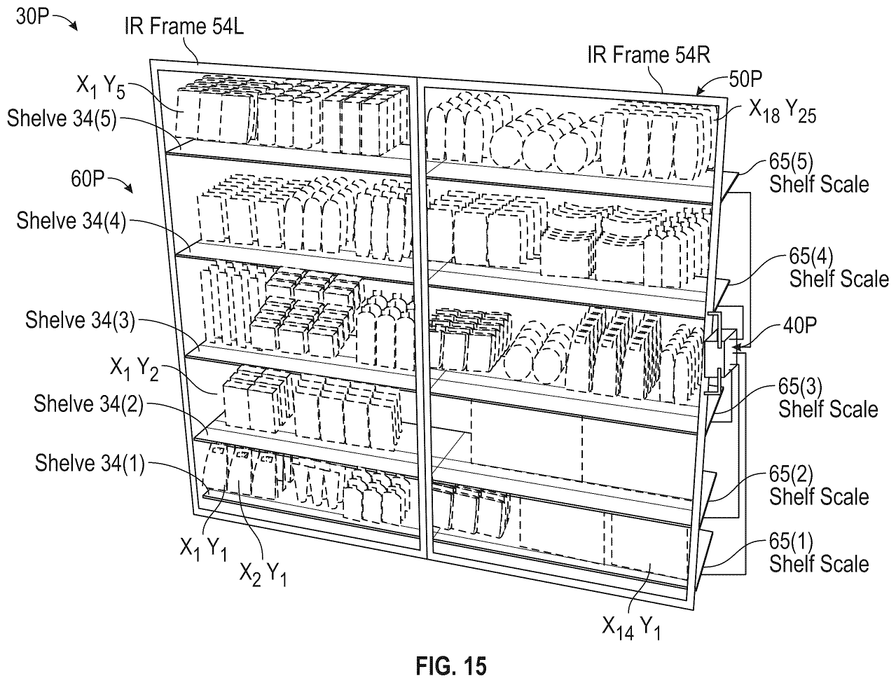

Application on pantry—having this system on a blind customer home so the system can tell you what products are taken from the pantry and it indicates the product taken. FIG. 15 illustrates another possible application of one or more aspects of the present invention. Instead of plural vertically spaced horizontal shelves or racks in a micro-market setting, the system 30P could be applied in an analogous way to even a home kitchen pantry having a set of vertically-spaced shelves 34. A plurality of pantry food items can be supported in pre-assigned positions on each of the pantry shelves (analogous to a plan-o-gram for a vending machine or micro market). A digital scale or weight sensor 62 of a weight change monitoring subsystem 60P can be installed for each shelf 34(1) to 34(5). Each scale 62(1) to 62(5) would be dedicated to monitor weight at each of the five shelves 34(1) to 34(5), respectively. As such, each scale is monitoring for change of weight for a plurality of lanes of pantry items across a shelf; not at individual item lanes. Here a first reach through XY interaction frame 54L of an XY position detector subsystem 50P can be mounted to frame or surround pantry items on the left sides of shelves 34(1) to 34(5), and a second reach through XY interaction frame 54R can be mounted to frame or surround pantry items on the right sides of shelves 34(1) to 34(5). As such, each IR frame is monitoring for a human interaction for just one side of the overall pantry inventory, but for multiple inventory items on one half of each of multiple shelves. Thus, each sensor type monitors multiple items at the same time; again not individually.

A position solution circuit 40P would have a plan-o-gram 44 of starting inventory for the pantry. Anytime disruption of the light curtain of a frame 52L or 52R is sensed, the system 40P monitors for any change in weight. If indicative of a removal of an item, the system assumes one or more items at the sensed XY interaction position has been removed. The system can record the event and update the inventory of the pantry. One non-limiting application would be for a blind person. Not only could the system keep track of depletion of inventory automatically and alert the person of need for replenishment of one or more items, but by appropriate programming, the a priori knowledge of the system of what is at each XY location could audibly announce (through con text-to-voice conversion via a speaker) to the person the identity of any pantry item the person interacts with (by reaching through the frame and manually touching or handling). Otherwise, the system could work like other embodiments previously described. If the person removes an item, the system can record and store that event. As such, the system could benefit anyone as in tracking pantry inventory and allowing the user to check on what needs replenishment.

### Drawer—

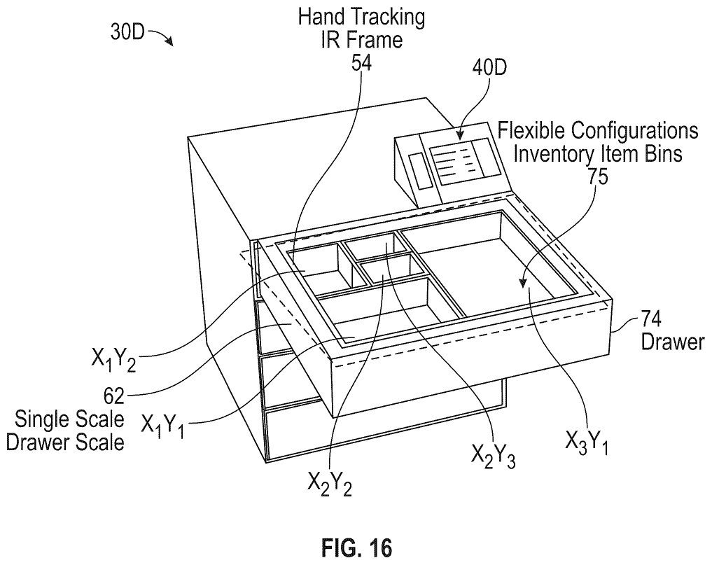

An IR XY position resolver frame 54 for XY human interactions is placed on top of a drawer 74 and the scale 62 for change of weight tracking on the drawer bottom, bins 75 are placed inside drawer 74. As with other embodiments disclosed herein, a combination of the weight and XY tracking can allow the tracking of inventory. As illustrated in FIG. 16, the basic combination of a supporting surface (here the bottom of a drawer), plural inventory items distributed on the supporting surface (here separated into compartments with bins 75), a digital scale 62 to sense change of weight from a baseline weight, and an XY position sensor (e.g., a reach-through IR light curtain frame 54 surrounding the interior of the drawer) allow automatic sensing of not only any interaction with a particular drawer item (by disruption of the light curtain at or near the XY drawer position of an item on a reach-through by a person's hand or finger(s)), but sensing if that product is removed (by sensing difference in baseline weight and weight after the sensed interaction). In these cases, the XY plane is basically horizontal, as opposed to being vertical in the pantry or micro market examples. But the concept is the same. The drawer items are arranged in a pre-determined manner in the interior of the drawer. As such, the system has a priori knowledge of what product or item is at what XY footprint in the drawer. As indicated at FIG. 16, the items could have different sizes (including XY footprints). They could also have the same size, and XY footprint. Additionally, there could be bins or subdividers in the drawer that each house one or more items. There could be one item per bin, or multiple items in each bin. The reach-through XY location can be derived with the horizontal IR frame and an indication of removal of a product can be derived from monitoring change of weight of the drawer supporting surface and the items on it prior and after an interaction. Of course, as with any embodiment herein, the contents/partitioning of the drawer can be changed from time to time or according to need or desire, and the plan-o-gram (what item(s) and its weight are at what XY footprints) changed accordingly. Also, alternatively, some configurations could have the scale or weight sensor monitor weight of the whole drawer (e.g., not only the bottom supporting surface but sides and drawer rails; and even bins if used) as the baseline, and sense change of weight from removal of an item in the drawer.

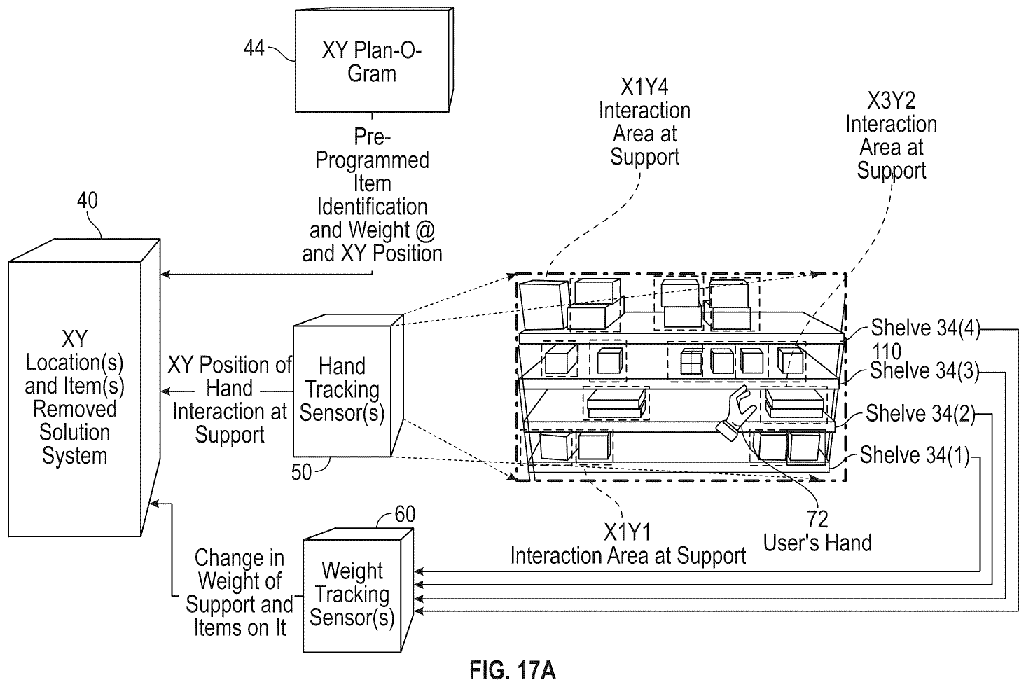

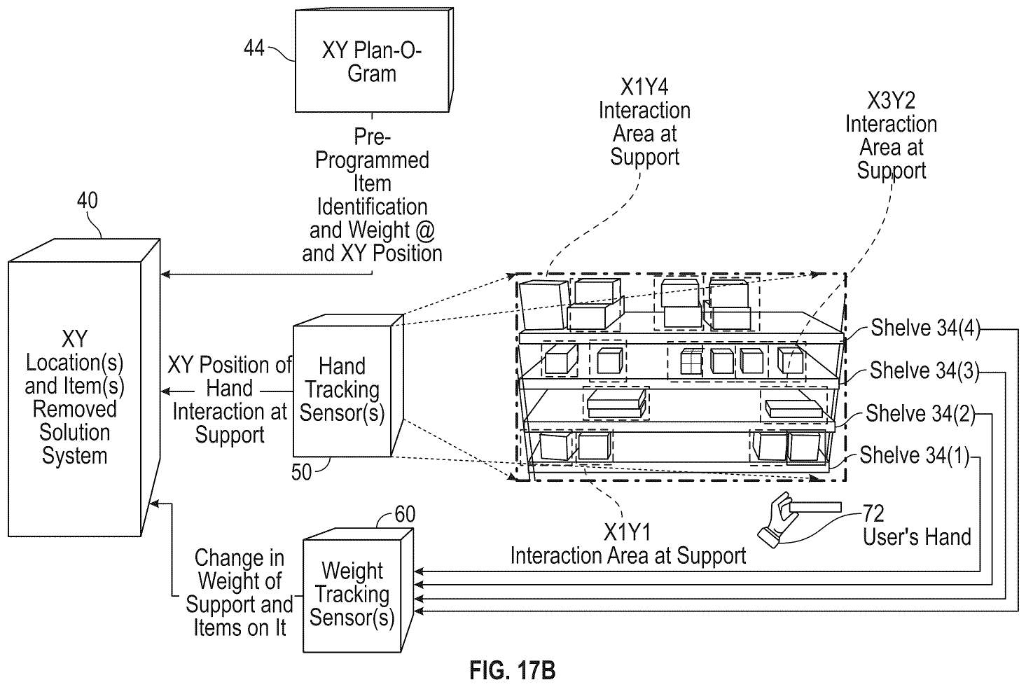

Open shelve inventory. FIGS. 17A-B are intended to diagrammatically illustrate another non-limiting example of application of one or more aspects of the disclosure. Here multiple vertical shelves of towels or linens, some XY locations having just one and others having plural stacked items, have an XY hand tracker 50 monitoring the whole shelve set, and a weight tracker 60 monitoring each shelf/support. As such, system 40 can sense and track a hand that reaches to any shelve and any position on a shelf to resolve an XY location of an interaction with any inventory location (FIG. 17A), and reference weight tracker 60 to determine if and how many items where removed (if any) from the interaction locations (FIG. 17B—where one items was removed). Analogous applications are, of course, possible.

As will be appreciated by those skilled in this technical art, variations and options are possible according to need or desire.

What is claimed is:

1. A system for generating an automatic detection solution of location and number of one or more user-selectable items retrieved by a user from at least one support in a transaction during a pre-determined user-interaction session comprising:
a. at least one support each having a side-to-side width and a front-to-back depth, each support configured to store one or more user-selectable items along the front-to-back depth at each of a plurality of pre-determined solution detection areas, each matched to data about a specific user-selectable item along the side-to-side width of the support;
b. a weight sensor installed at each support and configured to sense and report a weight of the support and any user-selectable items on the support via a digital weight signal;
c. an XY location solution detection area sensor at or near the front plane of the one or more supports configured to sense and report user-interaction with any solution detection area of any support via a digital solution detection area signal; and
d. a programmable controller configured to receive the digital solution detection area signal and digital weight signal for each user-interaction with a solution detection area, and automatically generate or store the automatic solution of location and number of one or more user-selectable items retrieved from each solution detection area in the user-interaction by correlation of the solution detection area with support weight before and after the user-interaction.

2. The system of claim 1 further comprising:
a. generating and storing all automatic solutions of location and number of one or more user-selectable times retrieved in all user-interactions in a user- interaction session.

3. The system of claim 1 wherein the weight sensor comprises:
a. a digital scale for measuring weight of each support and any items on it, or one or more load cells for measuring weight of each support and any items on it; or
b. weight tracker that reports change of weight relative to an interaction.

4. The system of claim 1 wherein the location sensor comprises:
a. a touch screen comprising touch points correlated to each item location; or
b. a curtain of electromagnetic radiation between emitters and detectors configured to discern disruption by a penetration of a user's finger or hand and correlate the disruption to an item location; or
c. one or more cameras having an XY camera space correlated with XY inventory physical space;
d. a hand tracker sensor that generates an XY location relative to XY inventory physical space as a hand moves into or across XY inventory physical space.

5. The system of claim 1 further comprising:
a. a digital display configured to display item data for any item indicated, touched, or retrieved, the item data comprising one or more of:
i. item description;
ii. item price;
iii. item location; and
iv. item weight.

6. The system of claim 1 further comprising:
a. communicating the generated detection solution with external devices; the external devices comprising one or more of:
i. a kiosk;
ii. a mobile devices;
iii. a computer;
iv. a POS registers;
v. a display;
vi. a speaker.

7. The system of claim 7 wherein the external device operatively connects to one or more remote systems, the one or more remote systems comprising:
a. a wide area network; and
b. a local network.

8. The system of claim 7 where the external device further comprises one or more of:
a. a payment solution to track retrieved items and charge the user, the payment solution comprising one or more of:
i. credit or debit card;
ii. cash; and
mobile wallets
b. an inventory control solution to track items retrieved, communicate inventory data to a remote device; and/or store inventory data for planning and marketing.

9. The system of claim 1 wherein the support is one of:
a. a shelf;
b. a drawer or drawer bottom;
c. a shelf that is not enclosed;
d. a shelf that is enclosed in an enclosure, the enclosure comprising:
i. a cooler with one or more doors (with or without locks);
ii. a cabinet with one or more doors (with or without locks).

10. The system of claim 1 where the support comprises one of:
a. a free-standing shelf or rack configured for supporting at least one product with or without a dispenser;
b. a free-standing shelf or rack configured for supporting at least one product in a plurality of laterally-spaced front to back rows or lanes of the same product;
c. a free-standing plurality of shelfs or racks each configured for supporting at least one product in a plurality of laterally-spaced front to back rows or lanes of the same product;
d. a plurality of shelfs or racks in a partial enclosure open to users, each shelf or rack configured for supporting at least one product in a plurality of laterally-spaced front to back rows or lanes of the same product;
e. a plurality of shelfs or racks in a partial enclosure open to users via an unlocked door, each shelf or rack configured for supporting at least one product in a plurality of laterally-spaced front to back rows or lanes of the same product;
f. a plurality of shelfs or racks in a partial enclosure open to users via a lockable door, each shelf or rack configured for supporting at least one product in a plurality of laterally-spaced front to back rows or lanes of the same product;
g. a drawer with lockable top and individual inventory item locations;
h. a drawer with individual inventory item locations delineated by bins;
i. a food pantry of plural vertically-spaced shelves.

11. A method of generating an automatic detection solution of location and number of one or more user-selectable items retrieved by a user from at least one support in a transaction during a pre-determined user-interaction session comprising:
a. providing an inventory of a plurality of sets of products at different lateral spaced positions on at least one support;
b. storing in a digital map of each position of each support an identification and weight of an item of the set of user-selectable items;
c. monitoring for an indication of user interaction with any set of user-selectable items by detection of disruption of a photoelectric field in front of a set of the user-selectable items;
d. monitoring for an indication of removal of one or more of the set of user-selectable items detected by the photoelectric field disruption based on a change of weight of the support and the user-selectable items on the shelf before and after the detected user interaction;
e. storing a digital solution of position removed user-selectable items at the position based on a combination of the position of the detected user interaction and the magnitude of weight change of the support of the detected user interaction compared to the prestored weight of the user-selectable items.

12. The method of claim 11 wherein the monitoring for an indication of user interaction comprises disruption of a photoelectric field comprising a curtain of IR light between sets of IR emitters and detectors that can resolve disruption of the photoelectric field in X and Y directions in the curtain.

13. The method of claim 12 wherein the location of disruption is resolvable to within approximately several thousandths of an inch.

14. The method of claim 11 wherein the monitoring for an indication of removal of a user-selectable item or items comprises comparison of weight difference prior and after a detected user interaction by one or more load cells between each support and a mount for each support.

15. The method of claim 14 wherein the weight difference is resolvable within approximately one ounce or less.

16. The method of claim 11 wherein the stored digital solution of position of removed user-selectable item and number of removed user-selectable items is communicated to another digital device.

17. The method of claim 16 wherein the other digital device comprises a controller associated with check out and payment.

18. The method of claim 17 wherein the check out and payment are at an automated micro market.

19. The method of claim 18 wherein the automated micro market comprises a plurality of inventories, each of the plurality of inventories associated with its own user interaction monitoring and support weight monitoring to produce a digital solution of position of removed user-selectable items for each of the plurality of inventories for one or more customer sessions.

20. The method of claim 19 wherein each of the digital solution of position of removed user-selectable items is communicated to a check out and payment interface.

21. A kit for use in generating an automatic detection solution of location and number of one or more user-selectable items retrieved by a user from at least one item support during a pre-determined user-interaction session comprising:
a. a weight sensor subsystem configured to be installed at each support and configured to sense and report a weight of the support and any user-selectable items on the support via a digital weight signal;
b. a photoelectric position detector subsystem configured to be installed at or near the front plane of each support configured to sense and report user-interaction with any solution detection area of any support via a digital solution detection area signal; and
c. a programmable controller configured to receive the digital solution detection area signal and digital weight signal for each user-interaction with a solution detection area, and automatically generate or store the automatic solution of location and number of one or more user-selectable items retrieved from each solution detection area in the user-interaction by correlation of the solution detection area with support weight before and after the user-interaction relative to a pre-stored digital map identifying each user-selectable item type, weight, and location on each support.

22. The kit of claim 21 configured to be installed in a micro market cabinet.

23. The kit of claim 21 configured to be installed in a plurality of micro market cabinets.

24. The kit of claim 21 configured to be installed in a drawer.

25. The kit of claim 21 configured to be installed in a food pantry.

26. A system for generating position and number of inventory items taken from an array of inventory items on one or more inventory supports comprising:
a sub-system configured to track a hand relative to an XY plane correlated to the array of inventory items and, at any time, resolve hand position relative that plane,
a sub-system that also tracks weight of each support and any items on that support to resolve if an item has been removed from that support by a decrease in weight correlated to an item;
so that the inventory of items on the one or more supports can be automatically monitored, and both an XY solution correlated to a specific item of inventory interacted with, as well as number of items removed from that XY interaction location can be resolved and stored for inventory tracking.

27. The system of claim 26 wherein the hand tracker subsystem comprises an IR frame.

28. The system of claim 26 wherein the hand tracker subsystem comprises a digital camera.

29. A method for generating position and number of inventory items taken from an array of inventory items on one or more inventory supports comprising:
tracking a hand relative to an XY plane correlated to the array of inventory items and, at any time, resolve hand position relative that plane,
tracking weight of each support and any items on that support to resolve if an item has been removed from that support by a decrease in weight correlated to an item;
so that the inventory of items on the one or more supports can be automatically monitored, and both an XY solution correlated to a specific item of inventory interacted with, as well as number of items removed from that XY interaction location can be resolved and stored for inventory tracking.

30. The method of claim 28 wherein the hand tracking comprises sensing perturbation of a light curtain resolvable to XY position of inventory.

31. The method of claim 28 wherein the hand tracking is by image recognition in camera space resolvable to XY position of inventory.
